(19) United States
(12) Patent Application Publication
(10) Pub. No.: US 2025/0360425 A1
(43) Pub. Date: Nov. 27, 2025

(54) CONTROL METHOD, STORAGE MEDIUM, AND GAME CONTROL APPARATUS

(71) Applicant: KONAMI DIGITAL ENTERTAINMENT CO., LTD., Tokyo (JP)

(72) Inventors: Reiya Inagaki, Tokyo (JP); Tomoaki Miyagawa, Tokyo (JP); Takayo Kanegae, Tokyo (JP)

(73) Assignee: KONAMI DIGITAL ENTERTAINMENT CO., LTD., Tokyo (JP)

(21) Appl. No.: 19/295,910

(22) Filed: Aug. 11, 2025

Related U.S. Application Data
(63) Continuation of application No. PCT/JP2024/004676, filed on Feb. 9, 2024.

(30) Foreign Application Priority Data
Feb. 13, 2023 (JP) 2023-019712

(51) Int. Cl. A63F 13/812; A63F 13/45

(52) U.S. Cl. CPC A63F 13/812; A63F 13/45

(57) ABSTRACT

An individual instruction accepting unit accepts an individual instruction of an action for each of the plurality of operation target characters based on a user's operation. The automatic instruction unit, when accepting the individual instruction based on the user's operation for the action of some operation target character out of the plurality of operation target characters, gives an automatic instruction according to a game situation for at least one other operation target character than the some operation target character individually instructed, to perform a related action to the action individually instructed to the some operation target character.

### CROSS-REFERENCE TO RELATED APPLICATIONS

This application is a Continuation of International Application No. PCT/JP2024/004676, filed Feb. 9, 2024 in the Japanese Patent Office, which is based upon and claims the benefit of priority of the prior Japanese Patent Application 2023-019712, filed on Feb. 13, 2023, the entire contents of which are incorporated herein by reference.

### BACKGROUND ART

### Field of Invention

The present invention relates to a program, a game control apparatus, a game system, and a recording medium.

### Description of Related Art

Conventionally, there is a game in which a user progresses a game while instructing an operation to each of a plurality of operation target characters. For example, there is a baseball game in which a user can instruct each runner character on base to steal base (for example, Japanese Patent Application Laid-Open Publication No. JP 2006-129929).

In the above conventional game, for example, in a situation where the bases are loaded (or two runner characters are on bases), when the user wants to instruct two or three runner characters to steal base, the user needs to instruct each runner character to steal base, and complicated operations are required to realize the user's intention (strategy)

### SUMMARY

Therefore, one of the objects of the present invention is to realize a configuration in which an instruction reflecting a user's intension (strategy) can be given to a plurality of operation target characters without requiring a complicated operation.

A control method in one aspect of the present invention, which controls a game including a plurality of operation target characters to each of which a user can give an action instruction individually, includes:
accepting the individual instruction for the action of each of the plurality of operation target characters based on a user's operation; and
when accepting the individual instruction based on the user's operation for the action of some operation target character out of the plurality of operation target characters, giving an automatic instruction according to a game situation for at least one other operation target character than the some operation target character individually instructed, to perform a related action to the action individually instructed to the some operation target character.

A non-transitory computer-readable storage medium in another aspect of the present invention having recorded therein a program that is executed by a processor of an information processing apparatus and is for a control of a game including a plurality of operation target characters to each of which a user can give an instruction individually, the program causes the processor to
accept an individual instruction for an action of each of the plurality of operation target characters based on a user's operation; and
when accepting the individual instruction based on the user's operation for an action of some operation target character out of the plurality of operation target characters, give an automatic instruction according to a game situation for at least one other operation target character than the some operation target character to perform a related action to the action of the some operation target character.

A game control apparatus in another aspect of the present invention, including at least one processor, and a memory storing instructions executable by the processor, that executes a control of a game including a plurality of operation target characters to each of which a user can give an individual instruction of an action, causes the processor by executing an instruction to:
accept an individual instruction for an action of each of the plurality of operation target characters based on a user's operation; and
when accepting the individual instruction based on the user's operation for an action of some operation target character out of the plurality of operation target characters, give an automatic instruction according to a game situation for at least one other operation target character than the some operation target character to perform a related action to the action instructed to the some operation target character.

The object, characteristics and advantages of the present invention become more apparent by the detailed explanation and the accompanying drawings below.

### BRIEF DESCRIPTION OF THE DRAWINGS

FIG. 1 is a schematic block diagram illustrating an example configuration of a game system according to one embodiment of the present invention.

FIG. 2 is a diagram illustrating an example of an offensive side operation screen.

FIG. 3 is a diagram illustrating one example of a case where a steal base is instructed with runners on the first and the third bases.

FIG. 4 is a diagram illustrating one example of a case where a steal base is instructed with the bases loaded.

FIG. 5 is a diagram illustrating an example of a case where a cancellation of steal base is instructed.

FIG. 6 is a schematic functional block diagram illustrating one example of a functional configuration of a game system.

FIG. 7 is a diagram illustrating one example of an automatic instruction information table.

FIG. 8 is a diagram illustrating one example of a base runner management data.

FIG. 9 is a flowchart illustrating one example of a processing performed by a game system.

FIG. 10 is a flowchart illustrating one example of a processing performed by a game system.

FIG. 11 is a flowchart illustrating one example of a processing performed by a game system.

FIG. 12 is a diagram illustrating one example of a case where plural types of actions are selectively instructed to a base runner.

FIG. 13 is a diagram illustrating one example of a case where plural types of actions are selectively instructed to a base runner.

FIG. 14 is a diagram illustrating one example of a case where plural types of actions are selectively instructed to a base runner.

FIG. 15 is a diagram illustrating another example of an automatic instruction information table.

FIG. 16 is a diagram illustrating another example of a case where a steal base is instructed with runners on the first and the third bases.

FIG. 17 is a diagram illustrating another example of a case where a steal base is instructed with runners on the first and the third bases.

FIG. 18 is a diagram illustrating another example of a case where a steal base is instructed with runners on the first and the third bases.

### MODES FOR CARRYING OUT THE INVENTION

Hereinafter, modes for carrying out the present invention will be described with reference to drawings.

### [Example Configuration of Game System]

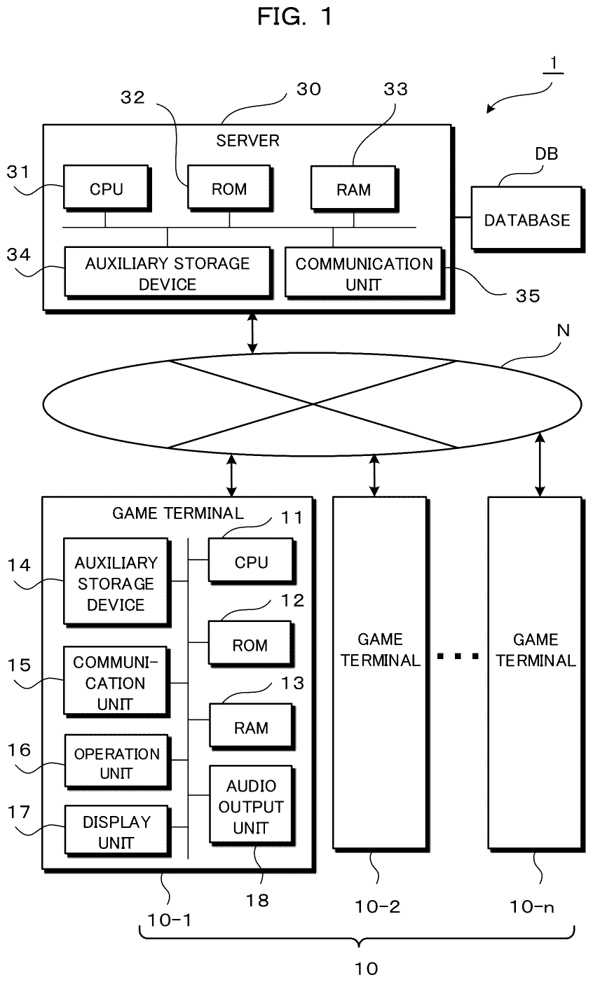

FIG. 1 is a schematic block diagram illustrating an example configuration of a game system 1 according to one embodiment of the present invention. The game system 1 includes a plurality of game terminals 10-n (n is a positive integer). 10-1, 10-2, . . . ) and a server 30. The game terminals 10-n and the server 30 in the game system 1 are communicably connected to each other via a network N such as the Internet. Here, since the plurality of game terminals 10-n have the same configuration, the plurality of game terminals 10-n are simply described as the “game terminal 10” when not particularly distinguished.

The network N according to the present embodiment is not limited to the Internet, and as long as the game terminal 10-n and the server 30 in the game system 1 can be communicably connected to each other, for example, a dedicated line, a public line (such as a telephone line, a mobile communication line, etc.), a wired LAN (Local Area Network), a wireless LAN, or the like may be adopted, or any of the above combined with the Internet may be adopted.

The game terminal 10 to be operated by a user is a computer that the user uses to play a game. The game terminal 10 is, for example, a home game machine (stationary or portable), a personal computer, a smartphone, a mobile phone terminal, a PHS (Personal Handy-phone System) terminal, a personal digital assistant (PDA), a tablet computer, a multi-functional television receiver (so-called smart television), a commercial-use game machine installed in amusement facilities, etc., and the like.

The server 30 is, for example, a server computer. The server 30 stores, for example, the information about the user's game in association with the user ID that uniquely identifies each user in a database DB, and manages the information. The database DB may be constructed in the server 30, or may be constructed in a server computer different from the server 30.

In the game system 1, it is possible to play against a computer (also called a CPU match) and communication battle. In the communication battle, for example, a user A who operates a game terminal 10-1 and a user B who operates a game terminal 10-2 can play a match game via the network N. In the case of this communication battle, for example, there is a method of directly communicating and playing between the game terminal 10-1 and the game terminal 10-2 matched by the server 30 by P2P (Peer to Peer) connection or the like. Alternatively, there is also a method of playing a communication battle by communicating data between the game terminal 10-1 and the game terminal 10-2 via the server 30. The communication battle may be performed in any method.

The communication between the game terminal 10-n and the server 30 uses HTTP (Hyper Text Transfer Protocol) operating on TCP/IP (Transmission Control Protocol/Internet Protocol) as the base protocol, and can be realized by implementing an application protocol specified in this system on an upper level.

On the other hand, the communication between the game terminal 10-1 and the game terminal 10-2 connected by P2P or the like can be realized, for example, by a UDP (User Datagram Protocol) which is a communication protocol on a transport layer of an OSI reference model, and which is mainly implemented on the IP protocol. Since the above UDP is a communication method that does not confirm the delivery of data or correct errors, but leaves the data sent to the game terminal on the other side, it has the advantage of low data reliability but high data transfer speed. Of course, it is also possible to use other existing protocols other than UDP for communication between the game terminal 10-1 and the game terminal 10-2, or to use a new protocol newly defined in the future.

Further, for example, in the game terminal 10-n having a short-range wireless communication function using a predetermined frequency band (for example, a frequency band of 2.4 GHz), a plurality of game terminals 10-n can be directly communicated to execute a match game.

### (Hardware Configuration of Game Terminal)

The game terminal 1 mainly comprises a CPU (Central Processing Unit) 11, a ROM (Read Only Memory) 12, a RAM (Random Access Memory) 13, an auxiliary storage device 14, a communication unit 15, an operation unit 16, a display unit 17, and an audio output unit 18, and these components are mutually connected via a bus line including an address bus, a data bus, a control bus and the like. Note that an interface circuit, an image processing unit, a sound processing unit, or the like are interposed between the bus line and the respective constituent elements as necessary, but the illustration thereof are omitted in the drawing.

The CPU 11 interprets and executes the instructions of the game program and controls the entire game terminal 10. The ROM 12 stores programs, data, and the like necessary for basic operation control of the game terminal 10. The RAM 13 stores various programs and data, and secures a work area for the CPU 11.

The auxiliary storage device 14 is a storage device for storing a game program, various data, and the like. As the auxiliary storage device 14, for example, a non-volatile semiconductor memory, a hard disk drive, a solid-state drive, or the like can be used.

The communication unit 15 includes a communication interface (not shown) and has a communication control function for data communication while a game is being executed. Here, the communication control function for data communication includes, for example, an Internet connection function, a wireless LAN (Local Area Network) connection function, and a short-range wireless communication function using a predetermined frequency band (for example, a 2.4 GHz frequency band). The communication unit 15 transmits a connection signal for connecting the game terminal 10 to the network N based on an instruction from the CPU 11, and receives information transmitted from the communication partner side and supplies it to the CPU 11.)

The operation unit 16 is provided for a user to input various operation commands to the game terminal 10. Examples of the operation unit 16 include a position input unit (a component of a touch panel) having a touch interface, physical buttons, a controller, an analog stick, a keyboard, a pointing device, and the like. Further, the operation unit 16 may have a voice input function by identifying a voice input from the audio input unit such as a microphone.

The display unit 17 is driven based on an image display command from the CPU 11 and displays a game screen, etc. Various known display devices such as liquid crystal displays and organic EL (Electro-Luminescence) displays can be applied to the display unit 17. Further, the display unit 17 can be a touch panel that combines a display device such as a liquid crystal display with a position input unit equipped with a touch interface. When the display unit 17 is configured as a touch panel, the game terminal 10 includes a touch input detection unit (not shown). When an indicator such as a finger or a pen comes into contact with the screen, the touch input detection unit detects contact position coordinates on the screen and supplies a coordinate signal to the CPU 11. In this way, the contact position on the screen of the display unit 17 is recognized by the CPU 11. It is not necessarily that the display unit 17 is integrated with the game terminal 10, and may be, for example, a television monitor externally connected to the game terminal 10. Thus, in the case of the television monitor or the like to which the display unit 17 is externally connected, the display unit 17 is not included in the configuration of the game terminal 10.

The audio output unit 18 generates an analog audio signal based on a pronunciation instruction from the CPU 11 and outputs an audio or the like from a speaker.

The game terminal 10 may include a recording media drive. Examples of the recording media drive include a DVD-ROM drive, a CD-ROM drive, a hard disk drive, an optical disc drive, a flexible disk drive, a silicon disk drive, a cassette media reader, and the like. In this case, a DVD-ROM, a CD-ROM, a hard disk, an optical disc, a flexible disk, a semiconductor memory, or the like may be used as the storage medium. The recording media drive reads image data, audio data, and program data from the recording medium, and supplies the read data to the RAM 13 or the like via a decoder.

### (Hardware Configuration of Server)

The server 30 mainly includes a CPU 31, a ROM 32, a RAM 33, an auxiliary storage device 34, and a communication unit 35, which are interconnected via bus lines including an address bus, a data bus, a control bus, and the like. In addition, an interface circuit is interposed between the bus line and each component as necessary. However, the illustration of the interface circuit is omitted here.

The CPU 31 interprets and executes commands of the system software and the application software to overall control the server 30. The ROM 32 stores a program necessary for basic operation control of the server 30. The RAM 33 stores various programs and data, and secures a working area for the CPU 31. The auxiliary storage device 34 is a storage device for storing programs, various data, and the like. As the auxiliary storage device 34, for example, a hard disk drive or a solid-state drive can be used.

The communication unit 35 includes a communication interface (not shown) and controls communication between each game terminal 10-n via the network N. Further, the communication unit 35 also controls communication with other servers not shown connected to the network N. For example, in the case of a system configuration wherein the server 30 is integrated with the social networking service (SNS), the communication unit 35 of the server 30 controls the communication with the SNS server. Further, for example, the server 30 controls the communication with a video distribution server that distributes a game video played by a user to spectators. Note that the server 30 can also have a video distribution function.

The server 30 can be configured by a single computer, but it can also be configured as a functionally distributed configuration in which each function of the server 30 is distributed to a plurality of servers. Alternatively, a load-balanced server may be adopted by providing a plurality of servers 30 on the network N to provide redundancy (multiplexing). Further, the server 30 may be configured as a cloud server using cloud computing technology.

The program or the data is supplied to the game terminal 10 or the server 30 from a remote location via the network N and is stored in the RAM 13, the auxiliary storage device 14, the RAM 33 or the auxiliary storage device 34.

A component (for example, an optical disc drive or a memory card slot, etc.) for reading programs and data stored on an information storage medium (for example, an optical disc or a memory card slot, etc.) may be provided in the game terminal 10 or the server 30. Then, the program or data may be supplied to the game terminal 10 or the server 30 via the information storage medium.

In the following, it is assumed that the game terminal 10 is a smartphone or a tablet computer equipped with a touch panel. Various operations such as touching, sliding, and touching-off on the screen are performed by means of an indicator such as a finger or a pen. In the following description, explanations will be given through the case of operations with a finger.

### [2. Outline of Example of Game]

The outline of an example of the game will be described below.

In the game system 1, various games can be executed. For example, various games can be played regardless of game format or genre, such as sports games (games based on baseball, soccer, tennis, American football, etc.), racing games, combat games, fighting games, digital card games, etc. A game may be executed such that the game terminal 10 performs data communication with the server 30 or other game terminal 10, or may be executed by the game terminal 10 alone. In the following, a game based on baseball will be described as one example of the game to be executed on the game system 1, and other games than the baseball game will be mentioned as necessary.

The baseball game of the present embodiment is equipped with various game modes such as a training mode, a team development mode, a lottery acquisition mode, an enhancement mode, a CPU battle mode, and a real-time battle mode, etc.

The training mode is a character development mode in which the user trains the character to be trained and creates his own original game character. In the present embodiment, the character of a pitcher or a fielder (including a catcher) can be developed in the development mode. Hereinafter, the game character created by the user in the training mode is referred to as a “training player”. The raining player can be used in other game modes, such as team development mode, a CPU battle mode, and a real-time battle mode. The team development mode is a game mode in which a team consisting of multiple player characters is trained. In the team development mode, various practices, matches, etc. are carried out.

The lottery acquisition mode is a game mode in which “event characters” that can be used as auxiliary objects when training the character to be trained in the training mode can be obtained by lottery. In this lottery acquisition mode, for example, a lottery of event characters (so-called gacha) given to the user from all event characters in the game is performed. In order for the user to execute the lottery acquisition mode, for example, a predetermined in-game points, billing items, etc. may be required.

The enhancement mode is a mode that can improve the level of event characters and strengthen them by combining event characters obtained in the lottery acquisition mode.

The CPU battle mode is also referred to as the computer battle mode. For example, the CPU battle mode may be given a name such as “stadium”. In this CPU battle mode, the user performs hitting, base running, pitching, or fielding operations of his or her own team's player characters composed of developed players trained in the development mode, and plays against the opponent's team automatically controlled by the CPU. For example, the opponent team automatically controlled by the CPU is a team made up of training players trained by other user in the training mode.

The real-time battle mode is a mode in which the user can communicate online with other users in a remote location via the network N. The user plays against the team of other user using a team composed of any of the development players, event characters, or fixed characters specified by a game management side, or using a mixed team thereof.

In this real-time matchup, for example, a game between the user's team and the opponent's team (another user's baseball team on the network N) proceeds in a communication battle based on the operation at each game terminal 10. For example, if a user is on the offensive side and the opponent's user is on the defensive side, the player character performs pitching or fielding according to the opponent user's operation (pitching operation, fielding operation), and the player character performs batching or stealing according to the user's operation (hitting operation, stealing operation). In such an action game, the game situation in the game is updated based on each user's operation for the player character. This real-time battle is also used in e-sports (electronic sports).

In the present embodiment, in the match executed in the CPU battle mode, the real-time battle mode, or the team development mode, respectively, it is possible to execute a game that includes a plurality of operation target characters, to each of which an action can be individually instructed by the user. For example, the user can individually instruct a steal base (an example action) for each runner character on base in the offensive scene of the user's team. Further, the game of the present embodiment has the following characteristic features. That is, in a case where a plurality of runner characters (an example of the plurality of operation target characters) are on bases, when the user instructs a steal base to some runner character(s), for at least one runner character other than the some runner character(s), a related action (steal base, etc.) to the instructed action of the steal base is automatically instructed by the processor (CPU 11 or CPU 31) according to the game situation. Namely, when the user instructs an action to some of the plurality of operation target characters, according to the game situation at that time, the processor automatically instructs the related action, that is intended (or may be thought to be intended) by the user, to the operation target character to which the user has not directly instructed. As a result, it is possible to instruct the user's intention (strategy) to a plurality of operation target characters whose actions can be individually instructed by the user without complicated operations according to the game situation. In addition, when the user instructs an action to some of the plurality of operation target characters, an automatic instruction is not always given to the operation target characters other than the instructed some operation target character, and the automatic instruction may or may not be given according to the game situation. In this meaning, this control refers to as a semi-automatic control. This will be described in detail below.

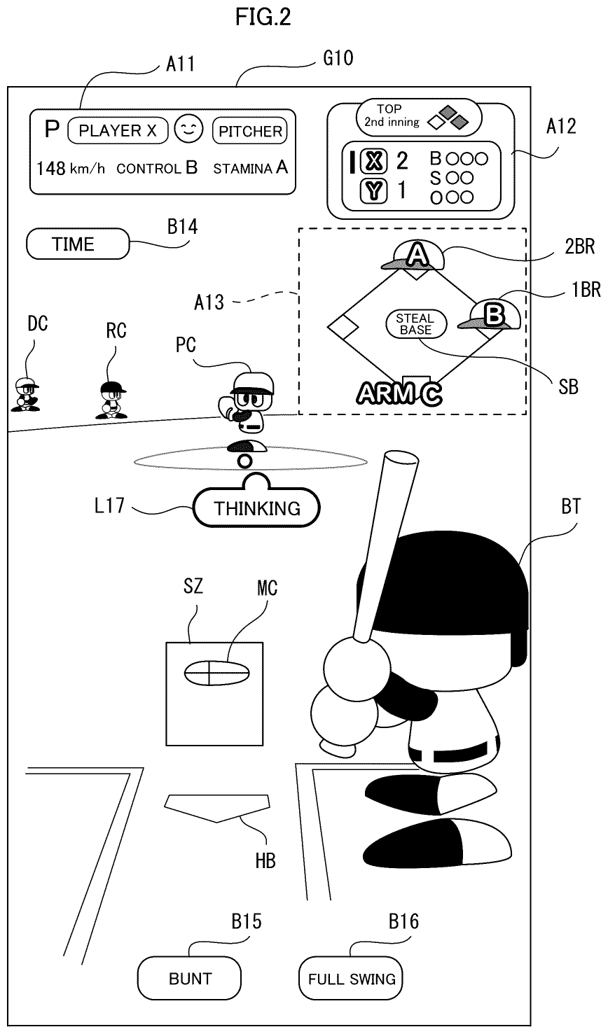

FIG. 2 illustrates an example of an offensive side operation screen G10. As illustrated in FIG. 2, in the offensive scene of the user's team (the scene where the batter character BT is at bat), an image captured by a virtual camera placed on the catcher's side rather than the home base HB is displayed. Therefore, an image of a predetermined angle looking at the pitcher character PC from the rear of the home base HB is displayed on the offensive side operation screen G10.

On the offensive side operation screen G10, displayed are a batter character BT of the user's team, a runner character RC displayed in the angle of view among the runner characters RC, a pitcher character of the opposing team, a fielder character DC in the field displayed in the angle of view among the fielder characters DC. On the offensive side operation screen G10, also displayed are a strike zone frame SZ, a meat cursor MC, a pitcher information display area A11, a game progress information display area A12, a runner operation area A13, a time button B14, a bunt button B15, a strong swing button B16, and the like.

In the pitcher information display area A11, displayed are the name of the pitcher character PC, ability parameters (ball speed, control, stamina), etc. In the game progress information display area A12, displayed are information such as the current innings, scores, ball count, out count, the runner's base status, etc. The meat cursor MC indicates the position where the batter character BT meets a ball with a bat. The bunt button B15 or the strong swing button B16 is a hitting mode switching button, and the user can make the batter character BT bunt or swing the bat strongly. At the time of offense, a user who operates a batter character BT performs a known hitting operation such as moving the meat cursor MC, etc. Further, by tapping the time button B14, it is possible to perform an operation such as replacing the batter character BT (substitute hitting) or replacing the runner character RC (substitute running).

### (Operation of Individually Instructing Each Runner Character to Steal Base)

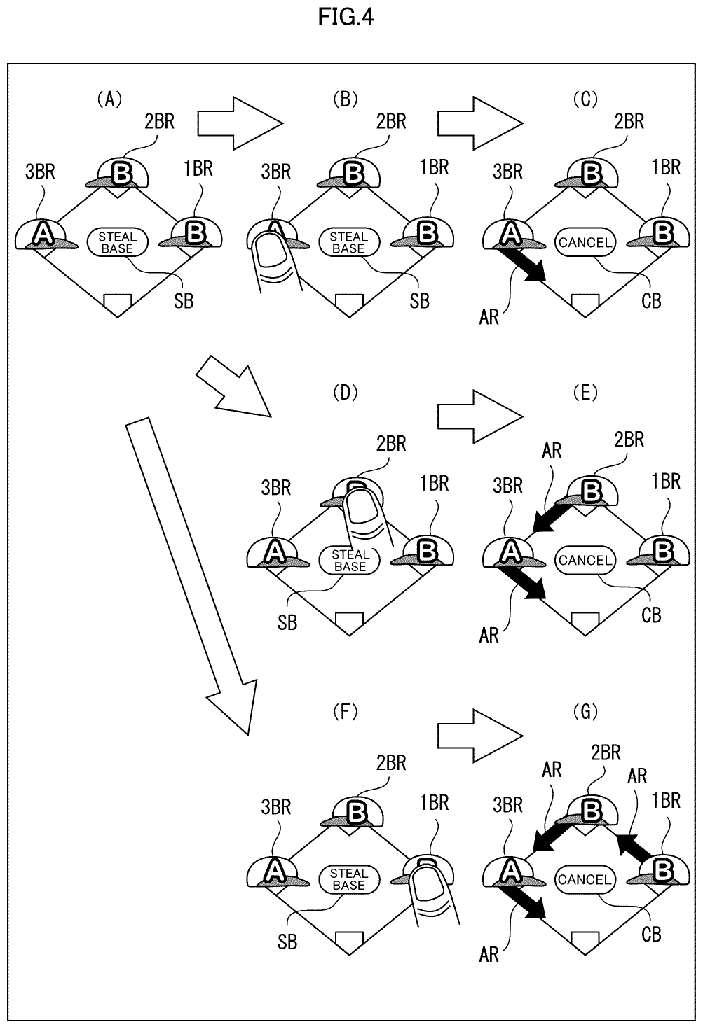

The runner operation area A13 is provided for a user to operate each runner character RC on base when playing offense. In the runner operation area A13, a command button (a first base runner button 1BR, a second base runner button 2BR, a third base runner button 3BR) for individually instructing a steal base for each runner character RC currently on base is displayed according to the base status. In the example of FIG. 2, since currently two runners are on the first base and the second base respectively, the first base runner button 1BR and the second base runner button 2BR are displayed in an active (operable) state. For example, when there is no runner on base, the command button for individually instructing a steal base is not displayed. For example, when the runner is only on the first base, only the first base runner button 1BR is displayed. For example, when the bases are loaded, the first base runner button 1BR, the second base runner button 2BR, and the third base runner button 3BR are displayed (see FIG. 4).

As a variation, it may be configured that all command buttons of the first base runner button 1BR, the second base runner button 2BR, and the third base runner button 3BR are displayed regardless of the base situation, and only the command button of the base with a runner is displayed active (operable), and the command button of the base with no runner is displayed in an inactive state (for example, gray layout display).

In the present embodiment, the first base runner button 1BR, the second base runner button 2BR, and the third base runner button 3BR have the shape of a hat. However, the shape, the color, etc., of these command buttons can be set arbitrarily.

Hereinafter, when explaining the command button for individually instructing an action such as a steal base for each runner character RC currently on base, it is simply described as “runner button BR” without particularly distinguishing between the first base runner button 1BR, the second base runner button 2BR or the third base runner button 3BR.

On each runner button BR, displayed is a running speed parameter associated with a runner character RC. Thereby, a user can grasp a level of the running speed of each runner character RC who is currently on base, and determine whether or not to instruct a steal base. In the example of FIG. 2, the first base runner button 1BR displays that the rank of the running speed parameter of the first base runner character RC is “B”. Further, the second base runner button 2BR displays that the rank of the running speed parameter of the runner character RC of the second base is “A”. Various ability parameters are associated with respective player characters of the user's team and the opponent's team, and the running speed parameter is one of the ability parameters. The ability parameters are displayed in 8 evaluation ranks of S, A, B, C, D, E, F, and G in descending order, with S for the ability value of 90 or more, A for 80˜89, B for 70˜79, C for 60˜69, D for 50˜59, E for 40˜49, F for 20˜39, and G for 19 or less. The higher the ability value or the rank of the running speed parameter is, the faster the runner character will run the base, and the higher the probability of successfully stealing a base.

Further, on the runner operation region A13, displayed is a arm strength parameter associated with the catcher character of the opponent team. The user can grasp the level of the arm strength of the catcher character and determine whether or not to instruct a steal base. In the example of FIG. 2, it is displayed that the rank of the arm strength parameter of the catcher character is “C”. The higher the ability value or the rank of the catcher's arm strength parameter, the lower the probability of successfully stealing a base.

### (Batch Instruction Operation to Plural Runner Characters to Steal Base)

On the runner operation area A13, in a situation where at least one runner is on base, displayed is the command button of the steal base button SB for instructing a common action of steal base with a batch instruction for all the runner characters RC currently on base. In a situation where no runner is on base, the steal base button SB is not displayed.

As a variation, it may be configured such that the steal base button SB is displayed regardless of the base situation, and the steal base button SB is displayed active (operable) in a situation where at least one runner is on base, and the steal base button SB may be displayed in an inactive state (for example, gray layout display) in a situation where no runner is on base.

As another variation, it may be configured such that in a situation where one runner or less (one runner or no runner) is currently on base, the steal base button SB is not displayed (non-active) and only in a situation where two or more runners are currently on base, the steal base button SB is displayed active so that a batch instruction of steal base can be given for a plurality of runners.

### (Specific Examples of Steal Base Instruction)

The runner button BR for giving an instruction to each runner character RC currently on base to steal base individually, and the steal base button SB for giving a batch instruction to runner characters currently on base are both command buttons of action reservation for making a steal base reservation. For example, when a user taps any of the active runner buttons BR to perform an operation of instructing the runner character RC to steal base, the stole base reservation is mad. Then, at the timing when the pitcher character PC starts a pitching operation, the runner character RC starts the action of steal base. Here, when the pitcher character PC starts a pitching motion, the pitcher character PC can be when the pitcher character PC starts not the action of pickoff throw but the action of raising foot to throw a ball in the direction of the home base.

A user can give an instruction of a steal base reservation to the runner character RC for each pitch by the pitcher character PC. A period of time in which an instruction for making a steal base reservation and for cancelling the reservation is set to a predetermined period of time. For example, as illustrated in FIG. 2, for each pitch, a thinking label L17 is displayed until the pitcher character PC starts the pitching motion, and while the thinking label L17 is displayed (before the pitching motion starts), the user can instruct the runner character RC to make a steal base reservation (or cancel the reservation). In the following, instructing the steal base reservation may be simply referred to as “instructing steal base”. In addition, the runner character RC may be simply referred to as the “runner”. Similarly, the pitcher character PC may be simply referred to as the “pitcher”.

In the game of the present embodiment, different controls are performed between the situation where no runner is on base just in ahead of the runner (or base) to which an individual instruction of steal base has been given by the user, and situation where a runner is on base just in ahead of the base runner instructed by the user (that is, the situation where the base(s) ahead front is occupied). In the latter situation, an automatic instruction of steal base is performed even for the runner to which a direct instruction is not given by the user. On the other hand, in the former situation, the automatic instruction is not performed. Firstly, the former case in which automatic instruction is not performed will be described, and then the case where automatic instruction is given will be described.

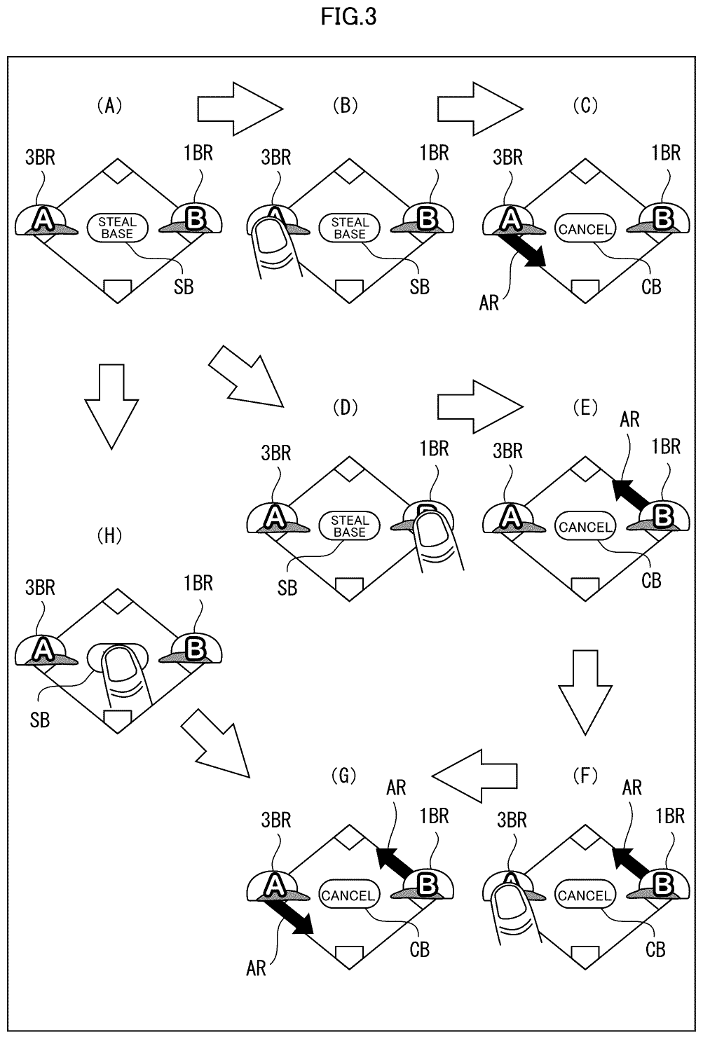

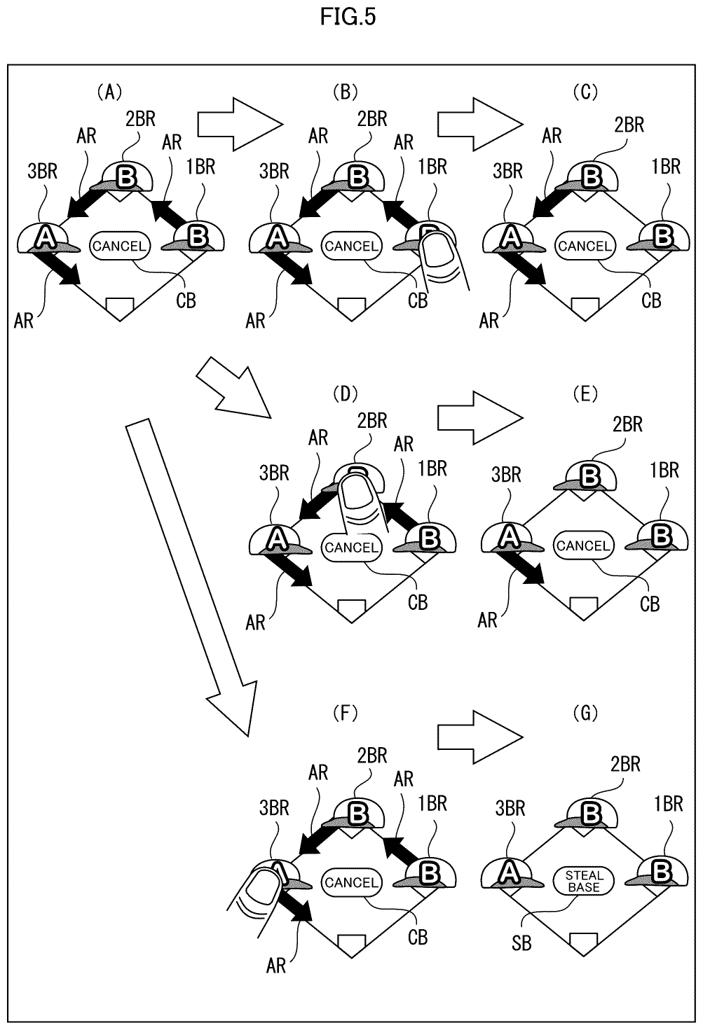

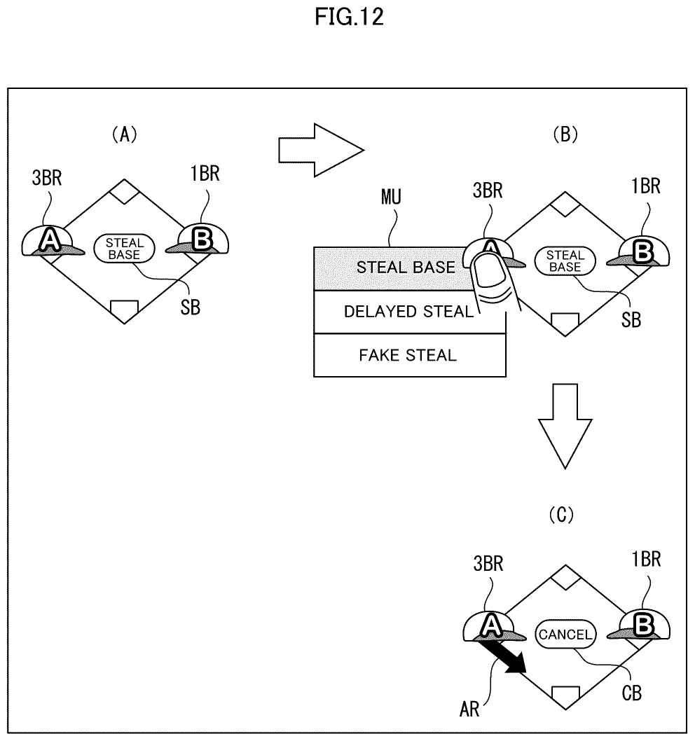

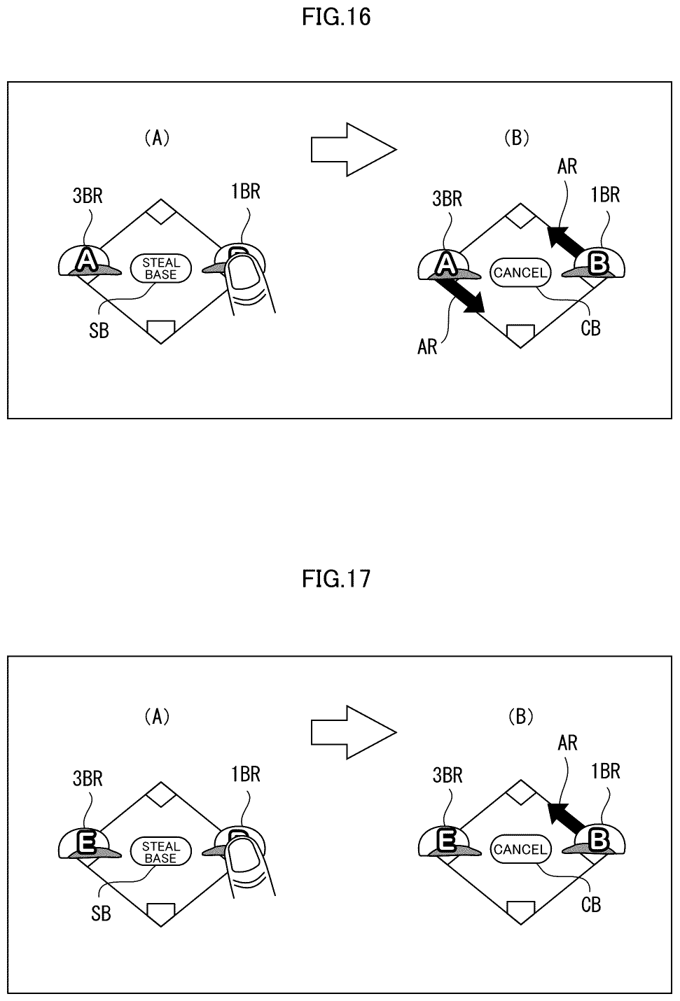

FIG. 3 is a diagram for explaining a steal base instruction in the situation with runners on the first and the third bases respectively. In FIG. 3, only the runner operation area A13 of the offensive side operation screen G10 is displayed, and the display of other areas and the arm strength parameters of the catcher character are omitted (the same applied to the cases shown in FIG. 4, FIG. 5, FIG. 12 to FIG. 14, FIG. 16 to FIG. 18 to be described later).

In FIG. 3, (A) illustrates a display example of a case where a steal base reservation has not been made for any runner on base. In this case, by tapping the runner button BR for each base, a user can individually instruct the runner on the corresponding base to steal base. For example, as illustrated in (B) of FIG. 3, the user can instruct the third base runner to steal base by tapping the third base runner button 3BR in the situation with the runners on the first base and the third base. In this case, as illustrated in (C) of FIG. 3, an arrow AR in a direction from the third base to the home base is displayed on the third base runner button 3BR as an information indicating that a steal base reservation has been made. Further, for example, as illustrated in (D) of FIG. 3, the user can instruct the first base runner to steal base by tapping the first base runner button 1BR in the situation with the runners on the first base and the third base. In this case, as illustrated in (E) of FIG. 3, an arrow AR in a direction from the first base to the second base is displayed on the first base runner button 1BR as an information indicating that a steal base reservation has been made to the first base runner.

Further, as illustrated in (F) of FIG. 3, in a situation where the steal base reservation has been made only for the first base runner, when the user further taps the third base runner button 3BR to instruct a steal base, as illustrated in (G), the steal base reservation can be made for the first base and the third base runners. Further, as illustrated in (C) of FIG. 3, after the steal base reservation is made for the third base runner first, if the user further taps the first base runner button 1BR to instruct the first base runner to steal base, the steal base reservation can be made both for the first base and the third base runners.

Further, as illustrated in (H) of FIG. 3, when the user taps the steal base button SB to give a batch instruction to steal base for all the runners, as illustrated in (G), the steal base can be reserved for both the first base runner and the third base runner.

As illustrated in (C), (E), (F) or (G) of FIG. 3, in a situation where a steal base reservation is made for one or more runners, the steal base button SB is changed to the cancellation button CB. The cancellation button CB is a command button to give a batch instruction to cancel the steal base reservation for all the runners to which the steal base reservation has been made.

FIG. 4 is a diagram for explaining a steal base instruction in a situation the bases are loaded. In FIG. 4, (A) illustrates a display example of a case where a steal base reservation has not been made for any runner on base. In this case, for example, as illustrated in (B) of FIG. 4, suppose that the user taps the third base runner button 3BR with the bases loaded to instruct the third base runner (the first runner) to steal base. In this case, since there is no runner on the base immediately ahead of the third base runner instructed, as illustrated of (C) of FIG. 4, the steal base reservation is made only to the third base runner instructed.

Although not illustrated, also in the case where a user individually instructs the second base runner (the first runner) to steal abase in a situation with runners on the first base and the second base, since no runner is on the base immediately ahead of the runners instructed, an automatic instruction of steal base is not given for the runner to which a steal base instruction has not been given by the user. Similarly, in a situation with runners on the second and the third bases, even if the user individually instructs the third base runner (the lead runner on base) to steal base, an automatic steal base instruction is not given.

### (Example Case of Executing Automatic Instruction of Steal Base)

Next, described is an example where an automatic instruction of steal base is performed even for a runner to which a user has not individually instructed to steal base.

For example, as illustrated in (D) of FIG. 4, suppose that the user taps the second base runner button 2BR with the bases loaded and instructs the second base runner to steal base. In this case, a control is executed such that a steal base instruction is automatically given also for the third base runner immediately ahead of the second base runner to which the user has instructed to steal base. As a result, as illustrated in (E) of FIG. 4, arrows AR indicating that steal base reservations have been made for two runners on the second and the third bases are displayed on the second base runner button 2BR and the third base runner button 3BR respectively.

Further, as illustrated in (F) of FIG. 4, it is assumed that the user taps the first base runner button 1BR in a situation bases are loaded to give a steal base instruction for the first base runner. In this case, such control is automatically executed that the automatic steal base instruction is given for the second base runner directly in ahead of of the first base runner to which the user directly instructed, and the third base runner just in ahead of the second runner. As a result, as illustrated in (G) of FIG. 4, arrows AR indicating that a steal base reservation has been made for three runners of the first base runner, the second base runner, and the third base runner, are displayed the bases respectively. In this way, also to a runner immediately ahead of the runner automatically instructed to steal base is also automatically instructed to steal base.

Although not illustrated, even when the user individually instructs the first base runner to steal base in a situation with the runners on the first and the second bases, an automatic steal base instruction is given for the second base runner which is right ahead of the runner individually instructed. Similarly, when the user individually instructs the second base runner to steal base in a situation with the runners on the second and the third bases, an automatic steal base instruction is given for the third base runner.

That is, when the user performs an operation of individually instructing a certain runner to steal base, and it is necessary to let other operation target character steal base, an automatic instruction is given to that runner to steal base without requiring a direct user's operation.

### (Specific Example of Steal Cancellation Instruction)

The user can individually instruct the runner on the tapped base to cancel the steal base reservation by individually tapping the runner button BR of the base runner to which the steal base reservation has been made. Further, in a state where a steal base reservation has been made for any runner on base, the steal base button SB is changed to the cancellation button CB (see FIG. 3 to FIG. 5). When the user taps the cancellation button CB, the steal base reservation is canceled at once for all the runners to which the steal base reservation has been made.

In the game of the present embodiment, different controls are performed between the situation with no base runner just behind the runner (or base) to which an individual instruction of cancellation of steal base reservation has been made, and the situation with a base runner just behind (that is, the case where the behind is occupied). In the latter situation, an automatic instruction is given to cancel the steal base reservation even for the runner to which a direct instruction has not been given by the user. On the other hand, in the former situation, the automatic instruction is not performed. Firstly, the former case where the automatic instruction is not given, and then the latter case where the automatic instruction is given will be described.

FIG. 5 is a diagram for explaining an instruction to cancel a steal base with the bases are loaded. In FIG. 5, (A) illustrates an example of a display of the case where the steal base reservation has been made for all the base runners. For example, as shown in (A) to (B) of FIG. 5, it is assumed that the user taps the first base runner button 1BR to instruct the first base runner (trailing runner) to cancel the steal base reservation. In this case, as illustrated in (C) of FIG. 5, the steal base reservation is canceled only for the instructed first base runner, and the arrow AR displayed on the first base is deleted.

Further, for example, in a situation where runners are on the first and the third bases, and the steal base reservation is made for both of the runners (see (G) of FIG. 3), when the user taps the first base runner button 1BR or the third base runner button 3BR, only the steal base reservation made for the runner on the base corresponding to the tapped base runner button is cancelled, and the automatic cancellation of the steal base reservation is not performed. Further, when the use instructs a cancellation of steal base reservation only for the first base runner in a situation where runners are on the first and the second bases, or when the use instructs a cancellation of steal base reservation only for the second base runner in a situation where runners are on the second and the third bases, the cancellation of the steal base reservation is performed only for the runner instructed.

### (Example of Executing Automatic Instruction to Cancel Steal Reservation)

Next, described is an example case of executing an automatic instruction to cancel the steal base reservation even for a runner who has not been individually instructed by the user to cancel the steal base reservation.

For example, as illustrated in (D) from the full base state (A) of FIG. 5, the user taps the second base runner button 2BR and instructs the second base runner to cancel the steal base reservation. In this case, a control that automatically instructs the cancellation of the steal base reservation is also executed for the first base runner at the base immediately behind the second base runner indicated by the user. As a result, as illustrated in (E) of FIG. 5, the arrow AR indicating the steal base reservation is deleted from the first base and the second base.

Further, as illustrated in (F) of FIG. 5, it is assumed that a user taps the third base runner button 3BR in a situation with the bases loaded to instruct the third base runner to cancel the steal base reservation. In this case, a control is executed such that the cancellation of the steal base reservation is automatically made also for the second base runner on the base immediately behind the third base runner instructed by the user and for the first base runner on the base immediately behind the second base runner. As a result, as illustrated in (G) of FIG. 5, the arrow AR indicating the steal base reservation has been made is deleted from the first base, the second base, and the third base. As described, an automatic instruction for cancelling the steal base reservation is made also for the runner on the base immediately behind the runner to which the automatic instruction for cancelling the steal base reservation.

Although not illustrated, when the user individually instructs the second base runner to cancel the steal base reservation in the situation with the runners on the first and the second bases, the first base runner immediately behind the instructed runner is automatically instructed to cancel the steal base reservation. Similarly, when the user individually instructs the third base runner to cancel the steal base reservation in a situation with two runners on the second and the third bases respectively, the second base runner is automatically instructed to cancel the steal base reservation.

That is, when the user performs an operation of individually instructing a certain runner to cancel the steal base reservation, and it is necessary to cancel the steal base reservation for other operation target character, an automatic instruction of cancelling the steal base reservation is given for the above other operation target character without requiring the direct user's operation.

### (Execution of Steal Base)

In the case where a steal base reservation has been made for any of base runner(s), when a pitcher starts a pitching motion, the base runner to which the steal base reservation has been made performs an action of stealing base. When the steal base has been made, it is determined whether or not the steal base has been successfully executed, for example, on the basis of probability. Here, the probability of successful steal base may be fixed, but may vary depending on the following conditions. For example, the probability of successful steal base may be set to vary such that the higher is the running speed of the runner, the higher is the probability, or the larger is the arm strength parameter of the catcher, the lower is the probability. Additionally, the probability of successful steal base may be set to increase in the following cases. That is, for example, the probability of successful steal base is set higher in the case where a batter swings and misses than that of the case where the batter does not swing. The probability of successful steal base is set higher in the case where a pitch speed is low than that of the case where the pitch speed is high. Similarly, probability of successful steal base is set higher in the case where a pitch type is a fast ball than that of the case where the pitch type is a curve ball, or in the case where a pitch is high than that of the case where the pitch is low.

Note that the runner, to which the steal base reservation has been made by the user, surely starts an action of steal base when the pitcher starts a pitching motion for the next pitch. That means in a situation where the steal base reservation has been made for the third base runner, if the user operates the batter character BT to bunt, it becomes a squeeze. Further, in a situation where the steal base reservation has been made for the base runner, if the user operates the batter character BT to hit a ball, it becomes a hit end run. Further, in a situation where the steal base reservation has been made for the base runner, if the batter character misses a pitch by the pitcher or swings and misses, it becomes a normal steal base. With this configuration, it is possible for a user to make various strategies by an operation of instructing the runner to steal base, and an operation for the batter character BT.

The pitcher of the opponent's team may throw a pickoff by specifying a base with a runner before starting a pitching motion. Here, it may be configured such that the pitcher consumes a predetermined parameter such as stamina, etc., for each a pickoff throw. Furthermore, the upper limit may be set for the number of times of the pickoff throw (for example, 3 times per at-bat, 5 times per inning, etc.). It may be arranged such that if a pickoff is thrown against a runner to which a steal base reservation has been made, the runner always be out. Alternatively, it may be arranged such that if the pickoff is thrown against the runner to which the steal base reservation has been made, the runner becomes out on the basis of probability. The user on the offensive side needs to develop a strategy in consideration of a count and a target base runner, i.e., a steal base instruction is to be made at which count and to which base runner, etc.

In the game of the present embodiment, for example, as illustrated in (E) of FIG. 4, when realizing a strategy in a situation with the bases loaded, to let two runners on the second base and the third base steal bases (not letting the first base runner steal base), a user has at least the following four options for operations 1) to 4).

1) With the bases loaded, the second base runner button 2BR is tapped. In this case, only with the individual instruction to one runner by the user, it is possible to instruct two runners to steal bases as intended by the user, and therefore the user's strategy can be realized without a complicated operation.

2) With the bases loaded, after tapping the first base runner button 1BR, the first base runner button 1BR is tapped again. This is an operation used in the case where the initial strategy was to let the three runners all steal base by tapping the first base runner button 1BR and also by an automatic instruction, but then, the strategy has changed so that only the first base runner out of the three runners does not steal base.

3) With the bases loaded, after tapping the third base runner button 3BR, tap the second base runner button 2BR. This is an operation used in the case where the initial strategy was to let only the third base runner steal base (home steal), but then, the strategy has changed so as to let also the second base runner steal base.

4) With the bases loaded, after tapping the steal base button SB, tap the first base runner button 1BR. This is an operation used in the case where the initial strategy was to let all of the three runners on base to steal base using a batch instruction by tapping the steal base button SB, but then, the strategy has changed so as not to let only the first base runner of the three runners to steal base.

As described above, according to the game of the present embodiment, when a user gives a steal base instruction to some of the plurality of runner characters to each of which the user can give an individual instruction to steal base (or cancel the steal base reservation), it is possible to automatically instruct according to the situation even for the runners to which the user has not given the instruction. Thereby, the user can realize his or her own strategy without a complicated operation.

### [3. Functional Configuration of Game System]

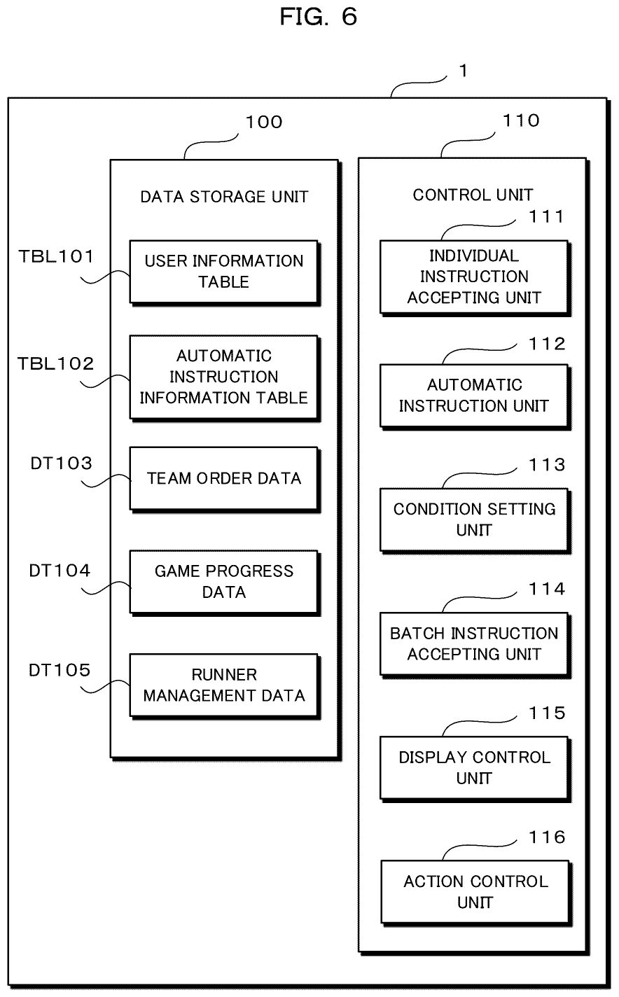

FIG. 6 is a schematic functional block diagram illustrating an example of a functional configuration of the game system 1. As illustrated in FIG. 6, the game system 1 includes a data storage unit 100. For example, the data storage unit 100 is realized by at least one of the database DB, the ROM 12, the RAM 13, the auxiliary storage device 14, the ROM 32, the RAM 33, and the auxiliary storage device 34. The data storage unit 100 stores data necessary for providing the game.

For example, various data for executing a game stored in the data storage unit 100 are stored in the database DB or the auxiliary storage device 34 of the server 30, and when the game terminal 10 accesses the server 30, the necessary data can be downloaded to the RAM 13 or the auxiliary storage device 14 of the game terminal 10. Further, the information on the results of the game executed by the game terminal 10 and changes in data are transmitted from the game terminal 10 to the server 30 in real time or at a predetermined timing, and the data stored in the database DB or the auxiliary storage device 34 of the server 30 can be updated as appropriate. Further, for example, at least a part of the game may be stored in the auxiliary storage device 14 of the game terminal 10, etc., so that the game can be executed offline without logging in to the server 30 in the game terminal 10 of each user.

As a specific example of the data stored in the data storage unit 100, data necessary for providing the above baseball game will be described. The data storage unit 100 stores a user information table TBL101, an automatic instruction information table TBL102, a team order data DT103, a game progress data DT104, a runner management data DT105, and the like. Although omitted in FIG. 6, the data storage unit 100 also stores a character information table or the like that stores information of all characters used in the game.

The user information table TBL101 stores information about all users registered in the game system 1. For example, in the user information table TBL101, stored are user's names, user's game levels, the information of training players, the information of owned event characters, the information of possessed items, the information of game points, the information of other users (mates, friends, etc.) associated with a user ID of each user. The information of a training player includes the character ID of the training player, the player's name, the ability parameter, etc., information created by the user in the training mode, and the like. The information on the ability parameters includes fielder abilities such as trajectory, meet, power, running speed, arm strength, defense ability, defensive position aptitude, unique fielding ability, etc., and pitcher abilities such as ball speed, control, stamina, types of pitches a pitcher can throw (arsenal), break of each pitch, unique pitcher ability, etc.

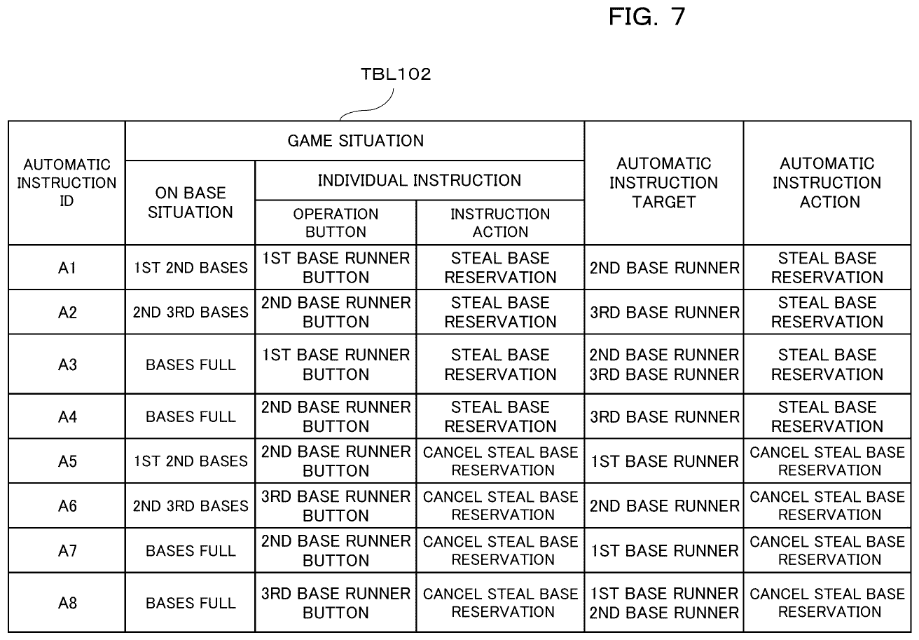

FIG. 7 illustrates an example of the automatic instruction information table TBL102. The automatic instruction information table TBL102 stores the information for giving an automatic instruction to other runner(s) than the runner instructed by the user when an individual instruction to the runner has been given by the user. For example, the automatic instruction information table TBL102 includes fields of an “automatic instruction ID”, a “game situation”, an “automatic instruction target” and an “automatic instruction action”. In the field of the “game situation”, the conditions of the game situation for automatic instructions are stored. Further, the “individual instruction” field includes the fields of “operation button” and “instruction operation”. For example, in the case of the automatic instruction ID=A1, stored is the information of executing the “steal base reservation” to the automatic instruction target of the “second base runner” when satisfying the condition of the game situation for instructing the “steal base reservation” by operating “the first base runner button” with “the runners on the first and the second bases”.

The team order data DT103 in FIG. 6 is information on the order of his or her own team used in the game. For example, the user can select and order a predetermined number (for example, 26) of characters from among the training players or the event characters owned by the user.

For the game progress data DT104, stored are, for example, the information on the progress of the game such as the score, innings, out count, ball count, and on-base status of each team.

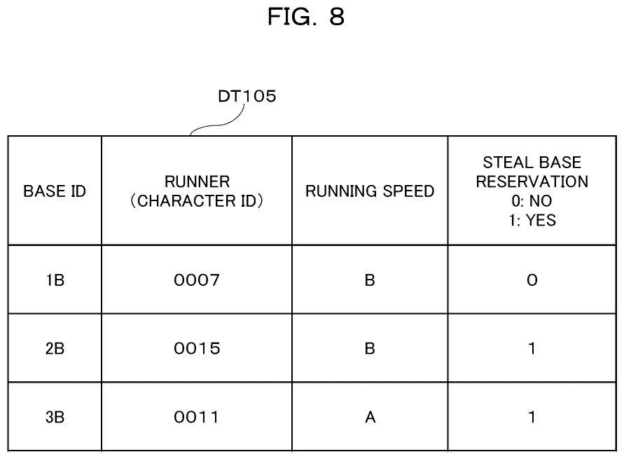

FIG. 8 illustrates an example of the runner management data DT105. The runner management data DT105 includes fields of “base ID”, “runner”, “running speed” and “steal base reservation”. The base ID is identification information for uniquely identifying each base. In the field of “runner”, the character ID of the runner on base is stored. In the field of “runner” of the base with no runner, the character ID is not stored. The character ID is an identification information for uniquely identifying each character. In the field of “running speed”, an information on the running speed parameters of the runner is stored. In the field of “steal base reservation”, an information (flag) indicating with or without a steal base reservation is stored. FIG. 8 illustrates an example in which two runners with the running speed in rank B are on the first base and the second base, and a runner of running speed A rank is on the third base, respectively, and a steal base reservation has been made for the two runners on the second base and the third base.

As illustrated in FIG. 6, the game system 1 includes a control unit 110. The control unit 110 is realized by executing a game program stored in the storage device (the ROM 12, the RAM 13, the auxiliary storage device 14, the ROM 32, the RAM 33 or the auxiliary storage device 34, etc.) by the CPU 11 of the game terminal 10 or the CPU 31 of the server 30. Here, a part of the functions of the control unit 110 may be realized by the CPU 11 of the game terminal 10, and the remaining functions may be realized by the CPU 31 of the server 30. Alternatively, all of the functions of the control unit 110 may be realized by the CPU 31 of the server 30, or all of the functions of the control unit 110 may be realized by the CPU 11 of the game terminal 10.

The control unit 110 executes a control of a game including a plurality of operation target characters whose actions can be instructed individually by the user. Here, the “user” is, for example, a person who plays a game by operating the game terminal 10. For example, the user identification information (user ID)) is set for each user or a game terminal 10 operated by each user, and each user is identified (specified) by the user identification information. The “operation target character” is a target character operated by the user in the game. The “operation target character” includes a person such as an athlete, a living creature such as an animal, a fictional character or living creature such as a monster, a game character indicating a non-living object such as a robot, and the like. In the above-mentioned example of the baseball game, the runner character RC corresponds to an example of the “operation target character”.

The “plurality of operation target characters to each of which a user can give an individual instruction of an action” indicates there exist a plurality of operation target characters, to which the user can give instructions individually for their actions. For example, as in the above-described baseball game, when the user can individually instruct each of the runner character RC currently on base to steal base, two or more runner characters RC currently on base correspond to one example of “plurality of operation target characters to each of which a user can give an individual instruction of an action”. Further, for example, in baseball or other games, when it is possible to individually instruct each of the plurality of characters currently on defense to adjust their defensive positions individually (for example, move to forward defensive positions, etc.), the plurality of characters currently on defensive side correspond to one example of “plurality of operation target characters to each of which a user can give an individual instruction of an action”. Further, for example, in various games, when it is possible to individually instruct each of the plurality of characters to move or stop moving, the plurality of characters correspond to one example of “plurality of operation target characters to each of which a user can give an individual instruction of an action”.

As illustrated in FIG. 6, the control unit 110 includes an individual instruction accepting unit 111, an automatic instruction unit 112, a condition setting unit 113, a batch instruction accepting unit 114, a display control unit 115, and an action control unit 116.

The individual instruction accepting unit 111 has a function of accepting an individual action instruction for each of the plurality of operation target characters based on an operation by a user. Here, the “instruction of an action” includes an instruction to perform a predetermined action, and also an instruction not to perform an action, or an instruction to cancel the action. Further, the “action instruction” includes an instruction for an action to be performed immediately after the instruction, and also includes an instruction to reserve the action for the operation target character to perform the action when a predetermined condition is satisfied after the instruction.

In the above-described example of the baseball game, the individual instruction accepting unit 111 individually accepts an instruction for each of the plurality of runner character RCs on the bases based on the user's operation of the runner button BR (1BR, 2BR or 3BR) of each base.

The “individual action instruction for each of the plurality of operation target characters” includes an instruction of a specific one action (one kind of action) or an instruction of cancellation of the action to each of the plurality of operation target characters, and also includes a selective instruction from among the plural types of actions. For example, as in the above-described baseball game, an individual instruction by a user to each runner currently on base to steal base (the type of steal base is one type) or an individual instruction to cancel the steal base correspond to one example of the “individual action instruction for each of the plurality of operation target characters”. Further, as will be described later, an individual instruction selectively specified by a user among different types of actions such as a normal steal base, a delayed steal, and a fake steal, etc., given individually to each runner or an individual instruction to cancel the action correspond to one example of the “individual action instruction for each of the plurality of operation target characters”.

Regarding the user's operation of instructing an individual instruction of an action for each of the plurality of operation target characters, whether the user gives the instruction or not is arbitrary, and the user may not give the instruction to any of the plurality of operation target characters, or may give the instruction to one or more of the plurality of operation target characters, or may give the instruction to all of the plurality of operation target characters. Further, when the user gives the instruction of an action to two or more operation target characters among the plurality of operation target characters, the user can instruct the action to two or more operation target characters approximately at the same time.

When the individual instruction accepting unit 111 accepts instructions for some of the plurality of operation target characters, the automatic instruction unit 112 automatically instructs a related action according to the game situation to at least one operation target character other than the above some operation target character(s) instructed.

Here, “at least one operation target character other than the above some operation target character(s) for which an action instruction has been accepted” is defined to be some or all of the operation target characters for which individual instructions have not been given by the user among the plurality of operation target characters.

The “game situation” includes various situations that may occur in the game. For example, in the case of the baseball game, the base situation of runners (for example, with runners on the first base and the second bases, runners on the second and the third bases, runners on the first and the third bases, the bases are loaded, etc.) corresponds to one example of the “game situation”.

Further, for example, an out count (two outs or not, etc.), a ball count (two strikes or not, etc.), game progress (last inning or not, etc.), weather (sunny weather or rain, etc.), and the like can be included in the “game situation”.

In addition, the running speed of each of the current base runners is high or not, how high is the base runner can also be included in the “game situation”. That is, the level of the ability parameter of each operation target character (such as a current base runner) can also be included in the “game situation”.

Further, the arm strength of the opponent's catcher character is strong or not, and how strong is the arm strength can also be included in the “game situation”. That is, the level of the ability parameter of other character(s) than the operation target character can also be included in the “game situation”. Other than the above, various situations that may occur in the game can be applied to the “game situation” according to the type and content of the game.

The “related action” refers to an action of an operation target character to which an individual instruction has not been given by a user's operation, and “related action” is automatically instructed to perform in relation to the action of the some of the operation target character to which the individual instruction has been given by the user's operation. The “action” to be individually instructed to some operation target characters by the user, and the “related action” to be automatically instructed to the operation target character to which the individual instruction has not been given by the user may be the same action or may be actions of different types. For example, in the above-described example of the baseball game, the “action=steal base” to be individually instructed by the user and the “related action=steal base” to be automatically instructed are the same. For example, in the modified example to be described later, the “action=fake steal” to be individually instructed by the user and the “related action=steal base” to be automatically instructed are different types of actions.

The “automatic instruction” refers to an instruction given according to the game situation to the operation target character that is not directly instructed by the user, and the “automatic instruction” is given without a direction instruction by the user to the operation target character.

Further, the “automatically instructing the related action according to the game situation” includes the case where the related action is automatically instructed when it is necessary to let the operation target character(s), other than the directly instructed some operation target character(s), perform the related action according to the game situation at that time in relation to the user's individual instruction of the action given to some operation target character(s) out of the plurality of operation target characters. Further, other than the above inevitable situation, the “automatically instructing the related action according to the game situation” also includes the case where the game situation at the time, the user has given the individual instruction of the action to some operation target character(s) out of the plurality of operation target characters, is the predetermined game situation, the automatic instruction of the related action to the above action is given to the operation target character(s), other than the directly instructed some operation target character(s).

The condition setting unit 113 has a function of setting a condition of the game situation for the automatic instruction unit 112 to automatically instruct the related action. Here, the condition of the game situation set by the condition setting unit 113 may be set by default (for example, set in advance on the game management side) or may be set by the user as desired to be described later so that the automatic instruction intended by the user (or thought to be intended by the user) is executed.

In the above-described example of the baseball game, when the individual instruction accepting unit 111 accepts an individual instruction of steal base for some runners among the plurality of runners, the automatic instruction unit 112 automatically instructs at least one runner other than the individually instructed some runners to steal base as an example of the related action according to the game situation. As a specific example, in the case of the game situation in which the base(s) ahead of the runner, to which an individual instruction of steal base has been given, is (area) filled (i.e., with a runner on the base just ahead, or with two runners on the bases ahead), the automatic indicator unit 112 automatically instructs one or two runners on the base(s) ahead to steal base. Further, in the case of the game situation in which the base(s) behind of the runner, to which an individual instruction of cancellation of the steal base reservation has been given, is (are) filled (i.e., with a runner on the base just behind, or with two runners on the bases behind), the automatic indicator unit 112 automatically instructs one or two runners on the base(s) behind to cancel the steal base reservation. When an individual instruction is given by the user, the automatic instruction unit 112 gives the above-described automatic instruction according to the game situation, for example, referring to the information of the automatic instruction management table TBL102 illustrated in FIG. 7.

According to this configuration, when the user gives an individual instruction to some of the plurality of runners to perform an action such as steal base, the related action is automatically instructed according to the game situation as intended by the user (or thought to be intended) even to the runner to which the user has not directly instructed. As a result, it is possible to give appropriate instructions reflecting the user's intention (strategy) to the plurality of runners to each of which an individual instruction can be given by the user according to the game situation without a complicated operation. As a result, it is possible to reduce the operation time by the user. In particular, in a real-time battle performed between users, the configuration of the present embodiment is preferable since it is necessary to shorten the operation time.

By the way, the automatic instruction management table TBL102 of FIG. 7 stores beforehand the conditions of the game situation for the automatic instruction unit 112 to automatically give instructions as the information in the table format. The automatic instruction unit 112 can also give automatic instructions without using the automatic instruction management table TBL102. For example, the automatic instruction unit 112 may determine the base ahead of the runner, to which an individual instruction of steal base has been given, is filled each time without referring to the automatic instruction management table TBL102, to give an automatic instruction to steal base to the runner to which an individual instruction. The same applies to the automatic instruction to cancel the steal base reservation. That is, the conditions of the game situation for the automatic instruction unit 112 to give automatic instructions (the base ahead of the runner, to which an individual instruction of steal base has been given, is filled) may be stored in any format.

The individual instructions accepted by the individual instruction accepting unit 111 and the automatic instructions by the automatic instruction unit 112 may respectively include instructions of reserving the action or the related action or cancelling the reservation of the action or the related action to the operation target character when the predetermined condition is satisfied after the instruction.

Here, the “reservation of an action” does not refer to the case where immediately after an individual instruction by the user or an automatic instruction by the automatic instruction unit has been made, the corresponding operation target character is instructed to perform the action or the related action as instructed, but refers to the case where the reservation of the action is made for the corresponding operation target character to perform the action or the related action when the predetermined condition is satisfied.

Further, the “predetermined condition” refers to the condition for instructing the corresponding operation target character, to which the reservation of an individual instruction by the user, or an automatic instruction of the reservation of the action has been made, to perform the action or the related action.

For example, in the case where an individual instruction or an automatic instruction for a runner as an example of the operation target character is the instruction of reserving “steal base”, “starting the pitching motion by the opponent's pitcher” corresponds to an example of the “predetermined condition”. For the “predetermined condition”, various conditions can be applied according to the content of the game or the content of the action reserved.

In the above example of the baseball game, the individual instruction to be accepted by the individual instruction accepting unit 111 and the automatic instruction by the automatic instruction unit 112 are the instruction to reserve steal base that reserves the target runner to steal base when the pitcher starts a pitching motion after the instruction is given, or the instruction to cancel the steal base reservation respectively. According to this configuration, when the user gives an individual instruction of a steal base reservation (or the cancellation of the steal base reservation) to a runner, according to the game situation at that time, even for runners who have not been directly instructed by the user, it is possible to automatically instruct the appropriate steal base reservation (or the cancellation of the steal base reservation) that reflects the user's intention (strategy).

The automatic instruction unit 112 may be configured such that when the individual instruction accepting unit 111 accepts the individual instruction of the action to the some of the plurality of operation target character(s), and it is necessary to let an operation target character, out of operation target characters other than the some operation target character, perform the related action according to the game situation, automatically instructs the operation target character to perform the related action.

Here, the “operation target character which needs to perform the related action according to the game situation” refers to such operation target character that from in consideration of the game situation when the user instructs the action to some of the operation target characters among the plurality of operation target characters, if the operation target character other than the above some of the operation target characters did not perform the related operation, the user would have a disadvantage in the game (or would not obtain a game profit), and therefore needs to perform the related action to avoid such disadvantage. In the example of the baseball game, description will be given through the case where each current base runner is an operation target character. For example, in the game situation where with runners on the first and the second bases, the user has given an individual instruction of steal base to the runner on the first base, if the runner on the second base would not steal base, there would be a disadvantage in the game that the runner on first base who attempted to steal base would be out. Therefore, in this situation, the runner on second base, which needs to steal base, corresponds to an example of the “operation target character that needs to perform the related action according to the game situation”. Further, for example, in the game situation where the user instructs the runner on the first base to steal base with the bases loaded, two runners on the second and the third bases, which need to steal base are the “operation target characters which need to perform the related action according to the game situation”.

According to the above configuration, when the user gives an individual instruction of steal base to the runner intended, according to the game situation at that time, if it is necessary to let also other runner(s) to steal base, an automatic instruction of steal base is given to the other character(s). Namely, in the situation where a plurality of operation target characters exist, to each of which the user can give an instruction individually, it is possible to realize the operation (strategy) intended by the user without operating them individually.

The control unit 110 may include the batch instruction accepting unit 114. The batch instruction accepting unit 114 has a function of accepting the batch instruction of the action for the plurality of operation target characters based on the operation by the user.

Here, the “the batch instruction of the action to the plurality of operation target characters” refers to giving the batch instruction of the action by the user to all the plurality of operation target characters. For example, a batch instruction command button is displayed on the screen, and an instruction of a predetermined action is given to all of the plurality of operation target characters by a single operation by the user, as an example of the “the batch instruction of the action to the plurality of operation target characters”. In the above example of the baseball game, an instruction to steal base to all the runners by operating the steal base button SB, or an instruction to cancel the steal base reservation to all the runners to which the steal base reservation has been made by the operation of the cancellation button CB correspond to examples of the batch instruction of the action to the plurality of operation target characters.

According to the above configuration, by combining the operation of an individual instruction such as a steal base (and an accompanying automatic instruction) and an operation of a batch instruction such as a steal base, various instructions of actions can be made to the plurality of runners, and the degree of freedom of instruction operation by the user is increased. For example, when realizing such strategy of letting two runners on the second base and the third base steal base with the bases loaded, the user can perform at least the above described four operations of 1) to 4).

The control unit 110 may include a display control unit 115 for displaying, for each of the plurality of operation target characters, a plurality of individual operation units on a screen for the user to give the individual instruction of the action, and displaying a parameter associated with the operation target character to be individually instructed in association with each of the plurality of individual operation units.

Here, the “individual operation unit” is displayed on the screen for allowing the user to give an individual instruction of an action to each of the plurality of operation target characters. The individual operation unit may be each operation target character itself, or an icon or an individual operation button, etc., corresponding to each operation target character. For example, when a plurality of individual operation units are displayed on a touch panel with a touch interface, the user may operate each individual operation unit by touch operation. Further, for example, the user may operate each individual operation unit by various input operations such as button operation of a controller or a cursor operation by a pointing device.

In the above-mentioned example of the baseball game, the runner button BR (1BR, 2BR, 3BR) of each base corresponds to an example of the “individual operation unit”.

The “parameter associated with the operation target character” is a parameter set to the operation target character. The “parameter associated with the operation target character” may be or may not be a numerical parameter. For example, the parameter indicating the evaluation of the ability or the performance of the operation target character (for example, a rank, a level, etc.) corresponds to an example of the “parameter associated with the operation target character”. For example, in the above example of the baseball game, the “running speed parameter” of each runner currently on base corresponds to an example of the “parameter associated with the operation target character”.

Regarding the above configuration of “displaying, for each of the plurality of operation target characters, a plurality of individual operation units on a screen for the user to give the individual instruction of the action, and displaying a parameter associated with the operation target character to be individually instructed in association with each of the plurality of individual operation units”, the parameter of the operation target characters may be displayed in the area of each individual operation unit (for example, the runner button BR of each base), or may be displayed in a vicinity of each individual operation unit.

In the above example of the baseball game, the display control unit 115 displays the rank of the running speed parameter associated with the target runner on the runner button BR (1BR, 2BR, 3BR) on each base. According to this configuration, it is possible to determine whether or not to give an instruction such as a steal base (an individual instruction, and an accompanying automatic instruction) to the runner in consideration of the runner's running speed parameters displayed on the runner button BR of each base.

The control unit 110 includes the action control unit 116 which controls the operation target character accepted by the individual instruction accepting unit 111 to perform the action, and controls the operation target character automatically instructed by the automatic instruction unit 112 to perform the related action. In the above example of the baseball game, the action control unit 116 controls the runner to which the instruction is accepted by the individual instruction accepting unit 111 to steal base (an example of the action), and also controls the runner automatically instructed by the automatic instruction unit 112 to steal base (an example of the related action). According to this configuration, it is possible to control not only the runner(s) to which the user has given individual instruction(s), but also the runners to which the user has not directly instructed to steal base(s) according to the game situation.

### [4. Processing]

Next, an example of the processing performed by the game system 1 of the present embodiment will be described below. Here, an example of the processing of the game system 1 that executes the control for the runner in the above-described baseball game will be described.

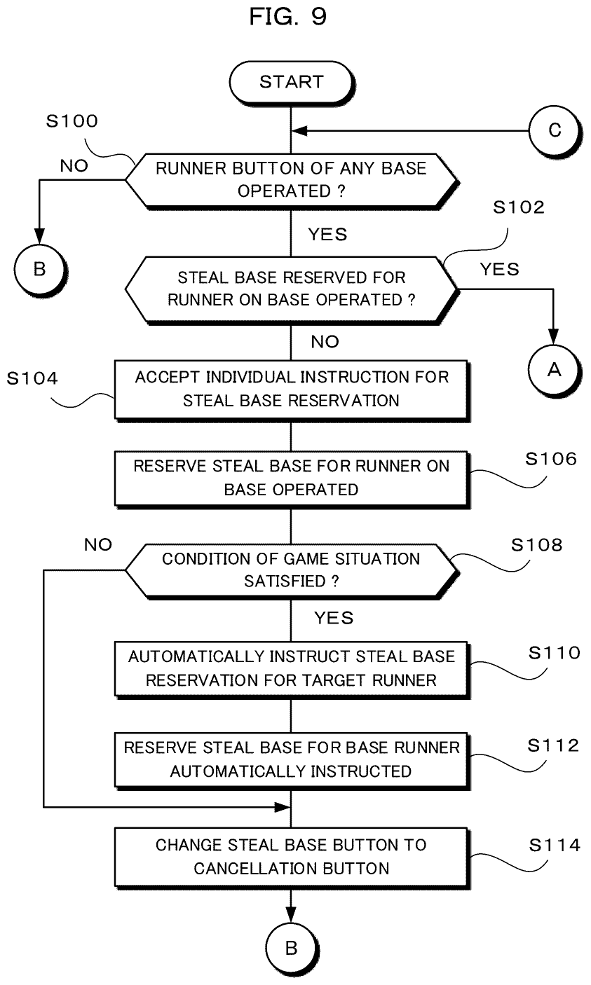

FIG. 9 to FIG. 11 are flowcharts illustrating an example of the processing of the game system 1. The below-explained processing is realized, for example, by the control unit 110 (the CPU 11 of the game terminal 10 or the CPU 31 of the server 30) which executes a game program stored in the storage device (the ROM 12, the RAM 13, the auxiliary storage device 14, the ROM 32, the RAM 33, the auxiliary storage device 34, etc.).

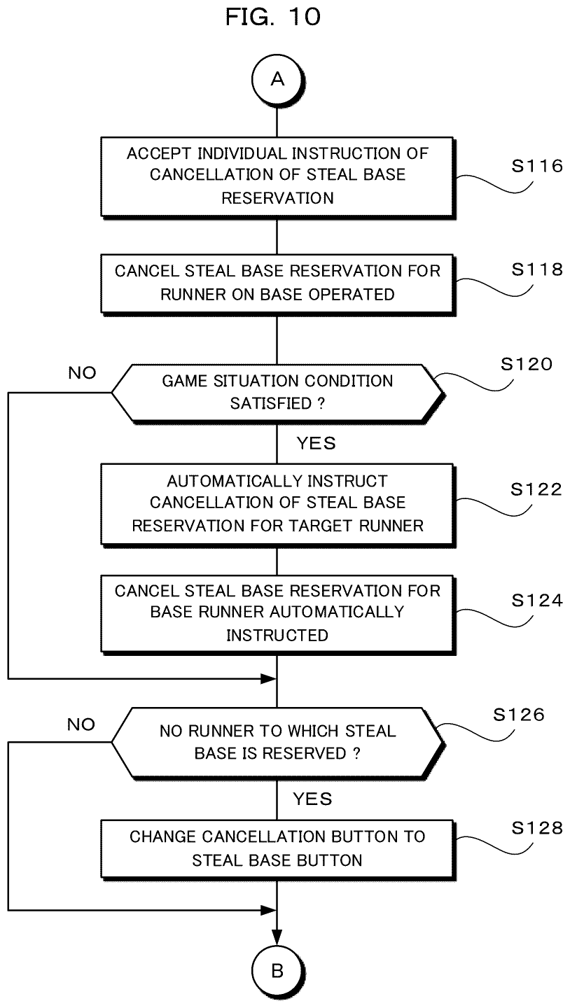

A user on the offense side can perform an operation of instructing a runner to steal base at an arbitrary ball count, before the pitcher starts a pitching motion. In step S100 of FIG. 9, the control unit 110 determines whether or not the runner button BR of any base has been operated by the user. Here, when the runner button BR of any base is operated (YES in S100), the control unit 110 determines whether or not a steal base reservation has already been made for the runner of the base operated (S102). If YES in step S102, the processing proceeds to step S104 to perform the routine of the case where the individual instruction of the steal base reservation has been made. On the other hand, if NO in S102, the processing proceeds to step S116 of FIG. 10 to be described later, to perform a routine of the case where the individual instruction for canceling the steal base reservation has been given.

In step S104, the control unit 110 accepts an individual instruction of steal base reservation by the user. Then, the control unit 110 reserves a steal base for the runner of the base operated by the user (S106). In this case, the control unit 110 updates the runner management data DT105 (see FIG. 8) and displays an arrow AR indicating that the steal base reservation has been made to the runner of the base operated by the user on the offensive side operation screen G10.

Further, the control unit 110 determines if the “game situation condition” is satisfied, for automatically instructing the runner on the base to which the individual instruction has not been given (S108). In the present embodiment, the control unit 110 determines if such “game situation condition” is satisfied that the base(s), in ahead of the base runner to which the individual instruction of steal base has been made, is occupied. For example, the control unit 110 may refer to the automatic instruction information table TBL102 illustrated in FIG. 7 and determine if the condition of the game situation is satisfied. When the control unit 110 determines that the condition of the game situation is satisfied (YES in S108), the control unit 110 automatically instructs the base runner of the automatic instruction target, to which the individual instruction has not been given (S110). Here, the runner of the automatic instruction target is the runner on the base just in ahead of the runner to which the individual instruction has been made by the user (when only one base just in ahead is occupied), or the two runners on the bases just in ahead and further in ahead (when both of the bases in ahead are occupied). Thereby, the control unit 110 makes the steal base reservation for the runner on base automatically instructed (S112), updates the runner management data DT105 in the example of FIG. 8. In the meantime, the control unit 110 displays on the offensive side operation screen G10, an arrow AR indicating that the steal base reservation has been made to the automatically instructed runner on base. Thereafter, the processing proceeds to step S114.

On the other hand, when the control unit 110 determines that the condition of the game situation is not satisfied (NO in S108), the control unit 110 proceeds to step S114 without executing the above-described automatic instruction. That is, the above-described automatic instruction may or may not be executed depending on the game situation. In step S114, the control unit 110 changes the steal base button SB to the cancellation button CB.

Next, described is the case where the processing when an individual instruction for cancelling the steal base reservation is given by the user. In step S116 of FIG. 10, the control unit 110 accepts an individual instruction by the user to cancel the steal base reservation. Then, the control unit 110 cancels the steal base reservation for the runner on the base operated by the user (S118). In this case, the control unit 110 updates the runner management data DT105 shown in FIG. 8 and deletes the arrow AR of the base operated by the user from the offensive side operation screen G10.

Further, the control unit 110 determines if the “condition of game situation” for giving an automatic instruction to the runner on the base to which the individual instruction has not been given (S120). In the present embodiment, the control unit 110 determines if such “condition of the game situation” is satisfied, that the base behind the runner on the base, to which the individual instruction of cancelling the steal base reservation has been made, is occupied. For example, the control unit 110 may refer to the automatic instruction information table TBL102 to determine if the condition of the game situation is satisfied. When the control unit 110 determines that the condition of the game situation is satisfied (YES in S120), the control unit 110 automatically instructs the cancellation of the steal base reservation to the runner on the base, to which the individual instruction has not been given, and which is the target runner of the automatic instruction (S122). Here, the target runner of the automatic instruction is the runner of the base just behind the runner to which an individual instruction has been made by the user (when only one base just behind is occupied), or the runner on the base just behind the runner to which an individual instruction has been made by the user and the runner on the base further behind (when both of the bases behind are occupied). As a result, the control unit 110 cancels the steal base reservation of the runner on the base automatically instructed (S124), updates the runner management data DT105, and deletes the automatically instructed base arrow AR from the offensive side operation screen G10. Thereafter, the processing proceeds to step S126.

On the other hand, when the control unit 110 determines that the condition of the game situation is not satisfied (NO in S120), the control unit 110 proceeds to step S126 without executing the above-described automatic instruction. That is, the automatic instruction to cancel the steal base reservation may be executed or may not be executed depending on the game situation.

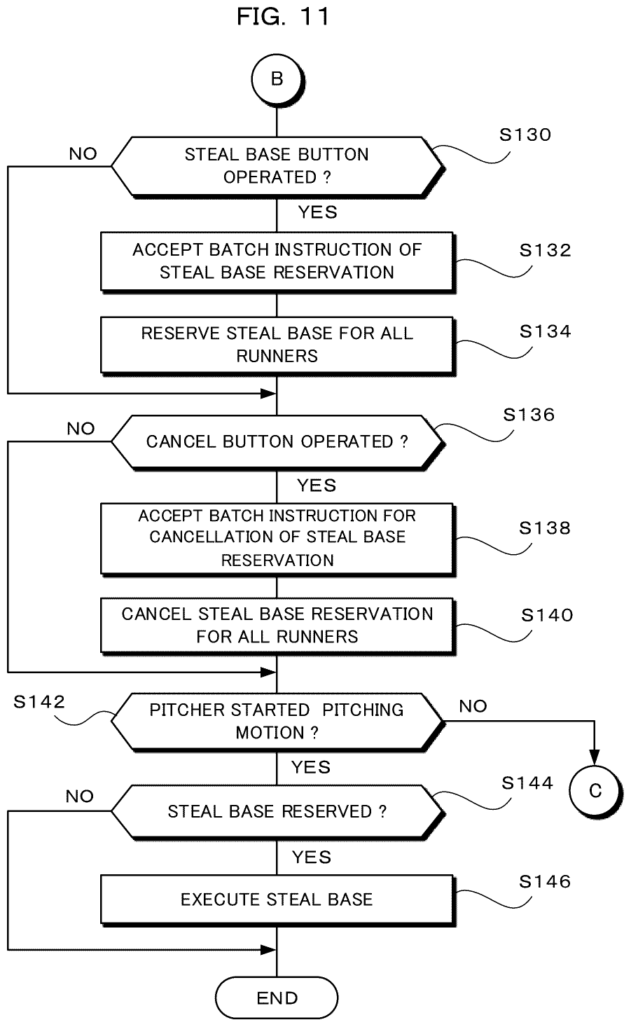

In step S126, the control unit 110 determines if no base runner remains to which the steal base reservation has been made. If NO in S126, the control unit 110 changes the cancellation button CB to the steal base button SB (S128). Then, the processing proceeds to step S130 of FIG. 11. On the other hand, if the base runner to which the steal base reservation has been made still remains (YES in S126), the processing proceeds to step S130 of FIG. 11 without executing step S128. Further, also in the case where the individual runner button BR has not been operated by the user (NO in S100 in FIG. 9), the processing proceeds to step S130.

In step S130, the control unit 110 determines if the steal base button SB has been operated by the user. If YES in S130, the control unit 110 accepts a batch instruction of steal base reservation (S132). In this case, the control unit 110 makes steal base reservations for all current base runners (S134), updates the runner management data DT105, and displays arrows AR on all bases with runners on the offensive side operation screen G10. Thereafter, the processing proceeds to step S136. Further, also in the case where the steal base button SB has not been operated by the user (NO in S130), the processing proceeds to step S136.

In step S136, the control unit 110 determines if the cancellation button CB has been operated by the user. If YES in S136, the control unit 110 accepts a batch instruction to cancel the steal base reservations (S138). In this case, the control unit 110 cancels the steal base reservations of all the current base runners to which the steal base reservations have been made (S140), updates the runner management data DT105, and deletes the arrows AR on all bases with the runners from the offensive side operation screen G10. Thereafter, the processing proceeds to step S142. Further, also in the case where the cancellation button CB has not been operated by the user (NO in S136), the processing proceeds to step S142.

The processing of steps S100 to S140 described above is repeated until the pitcher starts a pitching motion (until YES in S142). Namely, in this example, the operation of reserving steal base or cancelling the reservation can be performed for each pitch in the time period from when a pitcher is allowed to pitch until when the pitcher actually starts the pitching motion. In addition, the period, in which the operation of making the steal base reservation or the operation of cancelling of the steal base reservation can be performed, is not limited to the above, and can be set arbitrarily.

When the pitcher starts a pitching motion (YES in S142), the control unit 110 determines if the base runner, to which the steal base reservation has been made, exists (S144). Here, only when the base runner, to which the steal base reservation has been made, exists (YES in S144), the control unit 110 controls the corresponding base runner to steal base (S146).

### [5. Modifications, etc.]

The present invention is not limited to the above-described embodiments.

[5-1] In the above, mainly described are the examples of instructing a specific action (one type: steal base) or instructing the cancellation of the action. However, it may be configured to selectively instruct any of plural types of action. It may be further configured such that even in the case where the base ahead of the runner, to which an individual instruction has been given, is not occupied, the automatic instruction is executed according to the situation. Specific examples of this configuration will be described below.

FIG. 12 to FIG. 14 are diagrams illustrating an example of a case where an action is selectively instructed from a plurality of types to a runner in the base situation with runners on the first base and the third base. In the situation where a steal base reservation has not been made for any of the base runners as illustrated in (A) of FIG. 12, when a user taps the third base runner button 3BR as illustrated in (B) of FIG. 12, displayed is a select menu MU of a plurality of actions that can be instructed to the runner on the third base runner. FIG. 12 illustrates an example in which three choices of actions, a “steal base”, a “delayed steal” and a “fake steal” are displayed in the selection menu MU. The “steal base” is a normal steal base described above, where the runner starts taking off the base when a pitcher starts a pitching motion. The “delayed steal” is a steal base where a third base runner does not start taking off when the pitcher starts the pitching motion, and then starts taking off when the catcher, which caught a ball, throws the ball to the second base to prevent the first base runner from stealing the base. The “fake steal” is a motion where the base runner does not actually steal a base, but acts as though he is trying to steal when the pitcher starts the pitching motion.

The user can optionally select from the selection menu MU an action to be instructed to the third base runner. For example, as illustrated in (B) of FIG. 12, in the state immediately after the user has tapped the third base runner button 3BR, the “steal base” is provisionally selected by default, and from this state if the user immediately releases the finger tapped from the screen, this user's operation becomes the operation of instructing the third base runner to steal base. In this case, as illustrated in (C) of FIG. 12, an arrow AR is displayed on the third base indicating that a normal steal base reservation has been made

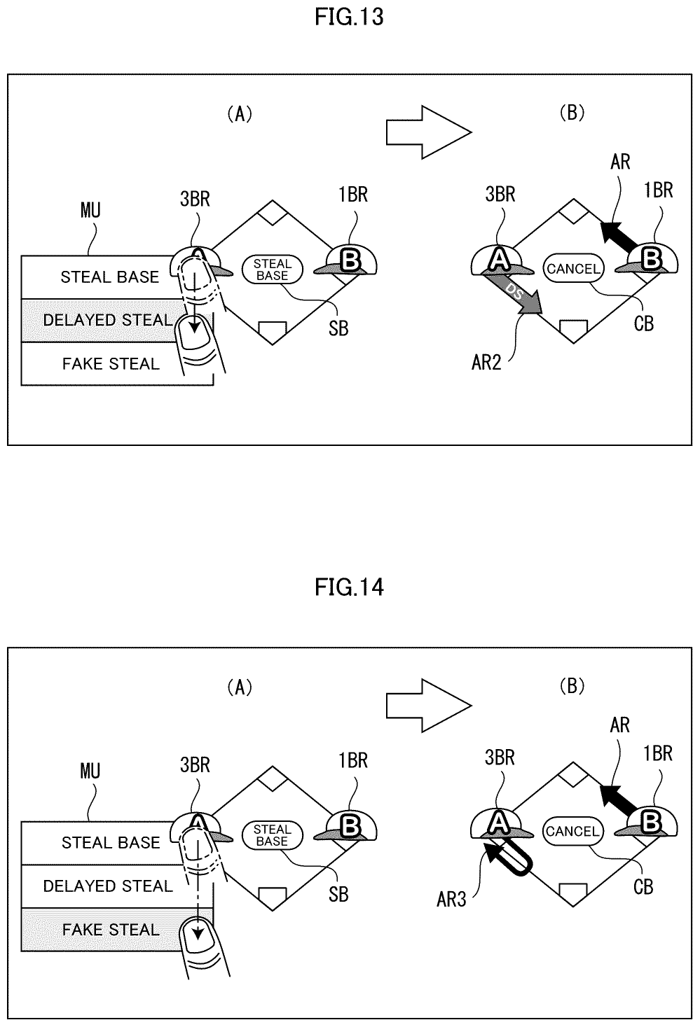

Further, as illustrated in (A) of FIG. 13, an instruction of the “delayed steal” to the third runner can be given by the following user's operation. That is, the user slides the finger tapped the third base runner button 3BR without releasing from the screen, to the display area of the “delayed steal of the selection menu MU, and then releases the finger from the screen. This user's operation becomes the operation of instructing the third base runner to delay steal. In this case, as illustrated in (B) of FIG. 13, an arrow AR2 indicating that the reservation of the delayed steal has been made is displayed on the third base. Here, the delayed steal of the third base runner is a strategy based on the assumption that the first base runner starts taking off the base before the third base runner starts taking off. Therefore, in the game situation where an individual instruction of delayed steal has been given to the third base runner with the runners on the first and the third bases, the automatic instruction unit 112 gives an automatic instruction of steal base to the first base runner as the related action. As a result, as illustrated in (B) of FIG. 13, the arrow AR is displayed on the first base, indicating that the reservation of the normal steal base has been made.

Here, it is preferable that the respective display pattens are different between the arrow AR indicating the normal steal base and the arrow AR2 indicating the delayed steal (for example, in color, density, displayed character or shape, etc.) so that a user can recognize the difference in instructed actions. (The same can be applied to the arrow AR3 indicating the fake steal, to be described later.) Further, the information indicating that some action has been instructed to the operation target character such as a runner, etc. is not limited to the form of the arrow AR, etc., as long as display patterns differ between with and without the action instruction.

Further, as illustrated in (A) of FIG. 14, an instruction of the “fake steal” to the third runner can be given by the following user's operation. That is, the user slides the finger tapped the third base runner button 3BR without releasing from the screen to the display area of the “fake steal” of the selection menu MU, and then releases the finger from the screen. This user's operation becomes the operation of instructing the third base runner to fake steal. In this case, as illustrated in (B) of FIG. 14, an arrow AR3 indicating that the reservation of the fake steal has been made is displayed on the third base. Here, the fake steal of the third base runner is a strategy to aid the successful steal base of the first base runner. Therefore, in the game situation where an individual instruction of fake steal has given to the third base runner with the runners on the first and the third bases, the automatic instruction unit 112 automatically instructs the first base runner to steal base as a related action. As a result, as illustrated in (B) of FIG. 14, the arrow AR is displayed on the first base, indicating that the reservation of the normal steal base has been made.

In the above, explanations have been given through the case where the user specifies the type of the action to be individually instructed to the third base runner using the selection menu MU, but is not limited thereto. For example, the user can specify the action to be instructed by the way or the type of user's operation, i.e., when the user taps the third base runner button 3BR once, “steal base”, twice “delay steal”, three time “fake steal”, and so on.

As illustrated in the examples of FIG. 12 to FIG. 14, in the case where the types of actions to be instructed to the same third base runner are different, even when the user gives an individual instruction to the same third base runner, an automatic instruction to the first base runner may or may not be executed. That is, the types of actions individually instructed by the user are also included in the conditions of the game situation for the automatic instruction unit 112 to automatically instruct the related action.

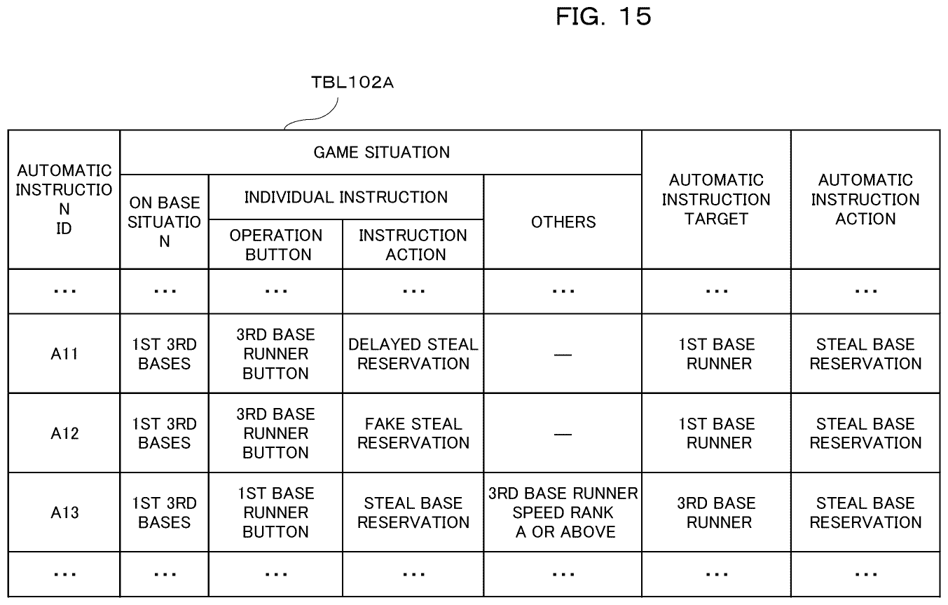

FIG. 15 is a diagram illustrating another example of the automatic instruction information table. In the automatic instruction information table TBL102A of FIG. 15, the field information “game situation” associated with the automatic indication ID=A11 is the condition of the game situation for executing the automatic instruction when the individual instruction of the above-described delayed steal has been made. Further, the field information “game situation” associated with the automatic instruction ID=A12 is the condition of the game situation for executing the automatic instruction when the individual instruction of the above-described fake steal has been made. For example, the automatic instruction unit 112 automatically instructs a related action to a runner to which an individual instruction has not been given by the user according to the game situation referring to the automatic instruction information table TBL102A.

[5-2] In the examples illustrated in FIG. 13 or FIG. 14, an automatic instruction is executed to the first base runner depending on the situation when an individual instruction has been given to the third base runner with the runners on the first and third bases. However, as explained below, it may be configured such that an automatic instruction may be executed to the third base runner depending on the situation when the individual instruction is given to the first base runner.

For example, as illustrated in (A) of FIG. 16 or FIG. 17, it is assumed that in the situation with runners on the first and the third bases, the user taps the first base runner button 1BR to give an individual instruction to the first base runner to steal base. In this case, since no runner is on the second base, the third base runner does not necessarily steal base even if the first base runner steals base. However, the automatic instruction unit 112 gives an automatic instruction to steal base to the third base runner when it is determined that the possibility of successful steal base is high referring to the ability parameter of the third base runner. As a specific example, when the running speed of the third base runner is in a predetermined rank (for example, A rank or above), the automatic instruction unit 112 determines that the possibility of successful steal base (home steal) of the third base runner is high, and gives the third base runner an automatic instruction of steal base as illustrated in (B) of FIG. 16. On the other hand, when the running speed of the third base runner is in less than a predetermined rank, the automatic instruction unit 112 does not automatically instruct the third base runner to steal base as illustrated in (B) of FIG. 17. For example, the automatic instruction unit 112 determines whether or not an automatic instruction of steal base is given to the third base runner referring to the information associated with the automatic instruction ID=A13 of the automatic instruction information table TBL102A of FIG. 15.

As illustrated in the examples of FIG. 16 and FIG. 17, even if the user gives individual instructions to the same first base runner, automatic instructions to the third base runner may or may not be executed depending on the ability parameters of the third base runner. That is, the ability parameters of the operation target characters are also included in the conditions of the game situation for the automatic instruction unit 112 to automatically instruct the related action.

[5-3] Similarly, for example, in the situation with runners on the first and the second bases or runners on the second and the third bases, when the user gives an individual instruction of steal base to a lead runner, it may be configured such that the automatic instruction unit 112 gives an automatic instruction also to the runner behind of the automatic instruction target to steal base only when the running speed of the runner behind the base runner of the automatic instruction target is in a predetermined rank or above. Further, with the bases loaded, when the user gives an individual instruction of steal base to the lead runner (the third base runner), it may be configured such that the automatic instruction unit 112 automatically instructs the second base runner to steal base when the running speed of the second base runner is in a predetermined rank or above, and instructs the first base runner and the second base runner to steal bases when the respective running speeds of both runners are in a predetermined rank or above.

[5-4] It may be configured that the automatic instruction unit 112 determines whether or not an automatic instruction is given by referring not only to the ability parameters of the character of the automatic instruction target but also, for example, the ability parameters of the opponent's characters. For example, the automatic instruction unit 112 compares the running speed rank of the runner of the automatic instruction target with the arm strength rank of the catcher of the opponent's team, and determines that the probability of successful steal bases is high if the running speed rank is higher than the arm strength rank, and gives an automatic instruction to the runner of the automatic instruction target to steal base.

[5-5] For the related action that the automatic instruction unit 112 automatically instructs the character of the automatic instruction target, it may be configured to set different content of the related action according to the game situation. This will be described below using the case with runners on the first and the third bases as an example.

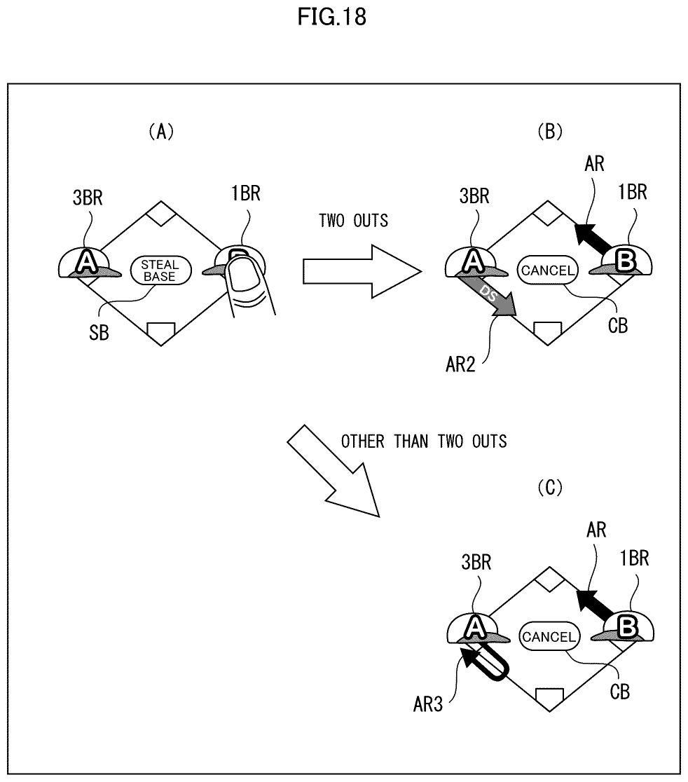

As illustrated in (A) of FIG. 18, consider the case where the user taps the first base runner button 1BR with the runners on the first and the third bases to give an individual instruction to the first base runner to steal base. For example, the delayed steal strategy is often used in the situation with runners on the first and the third bases with two outs. Therefore, as illustrated in (B) of FIG. 18, in the condition of two outs, the automatic instruction unit 112 may automatically instruct the third base runner to delay steal. As described above, the condition that the running speed of the third base runner is in a predetermined rank or above may also be included in the condition for automatically instructing delayed steal. On the other hand, as illustrated in (C) of FIG. 18, in the condition other than two outs, the automatic instruction unit 112 may automatically instruct the third base runner to fake steal to assist the successful steal base of the first base runner.

[5-6] It may be configured such that a user can set (register) beforehand the condition of the game situation for the automatic instruction unit 112 to automatically instruct a related action. Specifically, for example, it may be configured that the user may can arbitrarily set the condition of the game situation (the condition can be out count, running speed, etc.) that automatically instruct the third base runner to delay steal. With this configuration, one user may set the condition of the game situation for the running speed of the third base runner to be in A rank or above, and another user may set the condition for the running speed of the third base runner to be in B rank or above. For example, the user sets at least one condition such as an out count, the running speed of the runner of an automatic instruction target, the arm strength of a catcher, and the hitting ability of a batter, etc., on the condition setting screen (not shown). It is also possible to set the condition of multiple game situations (any of AND condition, OR condition, or a combination of AND condition and OR condition).

The condition setting unit 113 of the present embodiment has a function of setting beforehand the conditions of the game situation for the automatic instruction unit 112 to automatically instruct a related action based on a user's operation. Other than the case where the condition of the game situation is directly input by the user, the case where, the set condition of the game situation is confirmed by the computer, for example, when the user operates a predetermined button (a recommendation button, a random button, etc.) are included in the configuration of “setting beforehand the condition of the game situation based on the user's operation”. Each condition of the game situation set on the basis of the user's operation is added and stored, for example, in the automatic instruction information table TBL102A.

According to the configuration of the present embodiment, a user can set beforehand the condition of the game situation for the automatic instruction unit 112 to give an automatic instruction. With this configuration, it is therefore possible to appropriately reflect the user's intension (strategy according to the game situation) to the operation target character, such as a runner, etc., to which the user does not directly give an instruction.

For the automatic instruction to be given to the operation target character to which the user has not directly given an instruction, it may be configured such that the user can set (register) beforehand based on the user's operation as to the condition of the game situation and the type of the related action to be automatically instructed. Namely, each condition of the game situation may be set (registered) beforehand in relation to the corresponding related action to be automatically instructed.

[5-7] In the above, explanations have been given through the case of instructing a reservation of an action such as a steal base reservation, etc. However, instead of instructing the reservation of the action, it may be configured such that immediately after the user performs an operation of instructing the action to the operation target character, the action is executed by the operation target character as instructed. With this configuration, for example, with the user's operation of tapping the runner button BR of the base to be stolen at the timing the user determines the pitching motion starts, the target base runner starts stealing base immediately after the user's operation. Also with this configuration, as long as the condition of the game situation for the automatic instruction is satisfied, an automatic instruction for steal base is given even for a base runner to which a direct instruction has not been given by the user. Then, the runner to which the automatic instruction has been given immediately starts stealing base.

[5-8] The functions of the control unit 110 illustrated in FIG. 6 can be partially omitted.

For example, in the above, explanations have been given through the case where the display control unit 115 has a function of displaying the running speed rank of the target runner on the runner button BR (1BR, 2BR, 3BR) of each base.

Further, in the above, explanations have been given through the case where both an operation for the individual instruction by the runner button BR and an operation for the batch instruction by the steal base button SB or the cancellation button CB are permitted. However, it may be configured to permit only the operation for the individual instruction. In this case, the function of the batch instruction accepting unit 114 illustrated in FIG. 6 can be omitted.

[5-9]

In the above, examples of baseball games have been mainly described, but the present invention can be applied to other games as long as “the game including a plurality of operation target characters, to each of which an individual instruction can be given by a user”, regardless of the game format or genre, the present invention can be applied to a variety of games, for example, other sports games (soccer, tennis, American football, basketball, ice hockey, volleyball, rugby, etc.), combat games, role-playing games, simulation games, adventure games, or training games.

Examples of games other than baseball games include the following. For example, in the case of a game of developing a town in which a user operates to move individual characters such as a transport character (for example, a farmer) who carries a material, a security guard character (for example, a soldier) who guards the same, and other characters who are hindrances on the movement path, the control is performed as follows. For example, when a user gives each instruction to move the transport character, a movement instruction to a character (a security guard character and/or other character) who need to be moved is automatically given so as not to hinder the movement.

[5-10] The game terminal 10 and the server 30 can communicate with each other to transmit and receive various data, and both are information processing devices (computers) basically having the same hardware configuration equipped with a CPU, a ROM, a RAM, an auxiliary storage device, a communication unit, and the like. Therefore, some of the various functions described above may be realized by the CPU 11 of the game terminal 10, and the rest may be realized by the CPU 31 of the server 30. Alternatively, all of the various functions described above may be realized by the CPU 11 of the game terminal 10. Similarly, all of the various functions described above may be realized by the CPU 31 of the server 30.

[5-11] For the configuration having a memory control function for storing various information in the storage device, since the storage device itself is not included in this configuration, the storage device may be provided anywhere in and outside the game system 1. For example, the storage device may be a storage device (for example, the RAM 13, the auxiliary storage device 14, the RAM 33, the auxiliary storage device 34, the database DB, etc.) in the game system 1, or a file server (online storage) having a separate configuration.

[5-12]

A part or all of the functions of the control unit 110 described above may be realized by an integrated circuit such as LSI (Large Scale Integration), etc. Further, it may be configured that each of the above functions is integrated into a processor individually. Alternatively, some or all of the above-described functions may be integrated into a processor.

[5-13]

The computer-readable program of the present embodiment is stored in various types of computer-readable recording medium such as a hard disk, an optical disk (CD-ROM, DVD-ROM, etc.), a flexible disk, a semiconductor memory, or the like. The program is read out from the recording medium and executed by a computer constituting the game system 1 or the game control apparatus. Further, a program can be provided to the computer via a network including a communication line such as the Internet, WAN, LAN, or a dedicated line. A program stored in a file server (online storage) may be read out by a computer. Further, a computer may receive a program delivered from a distribution server. The storage medium also includes a storage medium provided in or outside the distribution server, accessible from the distribution server for distributing a program. A program code stored on the storage medium of the distribution server may not be in a code form that can be directly executed on the computer that received the program. Namely, as long as the program is executable by the computer after the download from the distribution server, the format of the program stored in the storage medium of the distribution server is arbitrary. Further, the program may be divided when downloading, and a plurality of divided programs may be merged after being downloaded respectively at different timings. Further, the distribution server that distributes each of the divided programs may not be the same. Further, the computer-readable storage medium includes those temporarily hold a program, such as a volatile memory like a RAM in a server that transmits a program via a network or a computer that receives it. Further, the program may be a differential program that can realize the above-described function in combination with a program already stored on the computer.

### [6. Appendixes]

From the above description, the present invention can be understood, for example, as follows. In order to clarify each aspect, reference numerals in the drawings are appended below in parentheses for convenience. However, the present invention is not limited to the drawings.

1) A program according to one aspect of the present invention causes a computer (1, 10, 30) that executes a control of a game including a plurality of operation target characters (for example, runners) to each of which an individual instruction of an action can be given, to function as:
an individual instruction accepting unit (111) accepting an individual instruction (steal base, or cancellation of steal base) for an action of each of the plurality of operation target characters based on a user's operation; and
an automatic instruction unit (112) when accepting the individual instruction based on the user's operation for the action of some operation target character out of the plurality of operation target characters, giving an automatic instruction according to a game situation for at least one other operation target character than the some operation target character individually instructed, to perform a related action to the action individually instructed to the some operation target character.

Here, for the “computer”, any computer including at least a processor and a storage device (memory) may be adopted. The processor is, for example, a CPU (Central Processing Unit). The processor may include a hardware such as a GPU (Graphics Processing Unit), a DSP (Digital Signal Processor), or an FPGA (Field Programmable Gate Array), etc., in addition to or instead of the CPU. For example, any of those including a processor and a storage device are included in the “computer”, such as a personal computer, a tablet computer, a smartphone, a stationary or portable game console, a commercial game console, a mobile phone terminal, a PHS terminal, a PDA, a multi-function television receiver with an information processing function, etc. Further, the “computer” may be composed of a plurality of devices capable of communication. For example, a system including a server and a terminal device is also included in the “computer”.

2) According to one aspect of the present invention, in the above aspect 1), the individual instruction accepted by the individual instruction accepting unit (111) and the automatic instruction by the automatic instruction unit include an action reservation instruction to reserve the action or the related action to the operation target character when a predetermined condition is satisfied after the individual instruction or the automatic instruction is given, or an instruction of cancelling the action reservation instruction.

3) According to one aspect of the present invention, in the above aspect 1) or 2), wherein the automatic instruction unit (112) is configured such that when accepting the individual instruction of the action to the some operation target character out of the plurality of operation target characters by the individual instruction accepting unit (111), and it is necessary to let an operation target character, out of operation target characters other than the some operation target character, perform the related action according to the game situation, automatically instructs the operation target character to perform the related action.

4) According to one aspect of the present invention, in any of the above aspect 1) to 3), further causes the computer function as a batch instruction accepting unit (114) that accepts a batch instruction of the operation for the plurality of operation target characters.

5) According to one aspect of the present invention, in any of the above aspect 1) to 4), further causes the computer function as a display control unit (115) displaying for each of the plurality of operation target characters, a plurality of individual operation units (1BR, 2BR, 3BR) on a screen for the user to give the individual instruction for the action, and displaying a parameter associated with the operation target character subject to the individual instruction in association with each of the plurality of individual operation units.

6) According to one aspect of the present invention, in any of the above aspect 1) to 5), further causes the computer function as a condition setting unit (113) setting beforehand a condition of the game situation for automatically instructing by the condition setting unit (113) the related action based on the user's operation.

7) According to one aspect of the present invention, in any of the above aspect 1) to 6), further causes the computer function as an action control unit (116) letting the operation target character, to which the individual instruction is accepted by the individual instruction accepting unit (111), perform the action, and letting the operation target character to which the automatic instruction is given by the automatic instruction unit (112), perform the related action.

8) A game control apparatus (10, 30) according to one aspect of the present invention that controls a game including a plurality of operation target characters (for example, runners) to each of which a user can give an individual instruction of an action includes:
an individual instruction accepting unit (111) accepting the individual instruction (steal base, or cancellation of steal base) for the action of each of the plurality of operation target characters based on a user's operation; and
an automatic instruction unit (112) when accepting the individual instruction based on the user's operation for the action of some operation target character out of the plurality of operation target characters, giving an automatic instruction according to a game situation for at least one other operation target character than the some operation target character individually instructed, to perform a related action to the action individually instructed to the some operation target character.

9) A game system (1) according to one aspect of the present invention including a server (30) and a terminal unit (10) capable of communicating with the server (30), that controls a game including a plurality of operation target characters (for example, runners) to each of which a user can give an individual instruction of an action includes:
an individual instruction accepting unit (111) accepting the individual instruction (steal base, or cancellation of steal base) for the action of each of the plurality of operation target characters based on a user's operation; and
an automatic instruction unit (112) when accepting the individual instruction based on the user's operation for the action of some operation target character out of the plurality of operation target characters, giving an automatic instruction according to a game situation for at least one other operation target character than the some operation target character individually instructed, to perform a related action to the action individually instructed to the some operation target character.

10) An information storage medium according to one aspect of the present invention is a non-transitory computer-readable storage medium storing the program in any of the above aspects 1) to 7).

11). A control method of the game system (1) or the game control unit (10 or 30) which controls a game including a plurality of operation target characters (for example, runners) to each of which a user can give an individual instruction of an action, includes:
an individual instruction step (S104) accepting the individual instruction for the action of each of the plurality of operation target characters based on a user's operation; and
an automatic instruction step (S110), when accepting the individual instruction based on the user's operation for the action of some operation target character out of the plurality of operation target characters, giving an automatic instruction according to a game situation for at least one other operation target character than the some operation target character individually instructed, to perform a related action to the action individually instructed to the some operation target character.

Note that the embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### DESCRIPTION OF REFERENCE SIGNS

1 . . . game system
N . . . network
DB . . . database
10 . . . game terminal
11 . . . . CPU
13 . . . . RAM
14 . . . auxiliary storage device
17 . . . display unit
30 . . . server
31 . . . . CPU
33 . . . . RAM
34 . . . auxiliary storage device
100 . . . data storage unit
110 . . . control unit
111 . . . individual instruction accepting unit
112 . . . automatic instruction unit
113 . . . condition setting unit
114 . . . batch instruction reception unit
115 . . . display control unit
116 . . . action control unit
TBL101 . . . user information table
TBL102, TBL102A . . . automatic instruction information table
DT103 . . . team order data
DT104 . . . game progress data
DT105 . . . runner management data
G10 . . . offensive side operation screen
A13 . . . runner operation area
1BR . . . first base runner button
2BR . . . second base runner button
3BR . . . third base runner button
AR/AR2/AR3 . . . arrows
SB . . . steal base button
CB . . . cancellation button

What is claimed is:

1. A control method which controls a game including a plurality of operation target characters to each of which a user can give an individual instruction of an action, includes:
accepting the individual instruction for the action of each of the plurality of operation target characters based on a user's operation; and
when accepting the individual instruction based on the user's operation for the action of some operation target character out of the plurality of operation target characters, giving an automatic instruction according to a game situation for at least one other operation target character than the some operation target character individually instructed, to perform a related action to the action individually instructed to the some operation target character.

2. The control method of claim 1, wherein the individual instruction and the automatic instruction respectively include:
an instruction of an action reservation for reserving the action or the related action to a corresponding operation target character when a predetermined condition is satisfied after the individual instruction or the automatic instruction is given; or
an instruction of cancelling the action reservation.

3. The control method of claim 1,
when accepting the individual instruction of the action to the some operation target character out of the plurality of operation target characters, and it is necessary to let an operation target character, out of operation target characters other than the some operation target character, perform the related action according to the game situation,
automatically instructing the operation target character to perform the related action.

4. The control method of claim 1, further:
accepting a batch instruction of the action to the plurality of operation target characters based on a user's operation.

5. The control method of claim 1, further:
displaying for each of the plurality of operation target characters, a plurality of individual operation units on a screen for the user to give the individual instruction of the action; and
displaying a parameter associated with the operation target character to be individually instructed in association with each of the plurality of individual operation units.

6. The control method of claim 1, further:
setting beforehand a condition of the game situation for automatically instructing the related action based on a user's operation.

7. The control method of claim 1, further:
letting the operation target character, to which the individual instruction is accepted, perform the action; and
letting the operation target character to which the automatic instruction is given, perform the related action.

8. A non-transitory computer-readable storage medium having recorded therein a program that is executed by a processor of an information processing apparatus and is for a control of a game including a plurality of operation target characters to each of which a user can give an instruction individually, the program causes the processor to:
accept the individual instruction of the action for each of the plurality of operation target characters based on a user's operation;
when accepting the individual instruction based on the user's operation for the action of some operation target character out of the plurality of operation target characters, give an automatic instruction according to a game situation for at least one other operation target character than the some operation target character individually instructed, to perform a related action to the action individually instructed to the some operation target character.

9. The storage medium of claim 8, wherein the individual instruction and the automatic instruction respectively include:
an instruction of an action reservation for reserving the action or the related action to a corresponding operation target character when a predetermined condition is satisfied after the individual instruction or the automatic instruction is given; or
an instruction of cancelling the action reservation.

10. The storage medium of claim 8, wherein the program causes the processor to:
when accepting the individual instruction of the action to the some operation target character out of the plurality of operation target characters, and it is necessary to let an operation target character, out of operation target characters other than the some operation target character, perform the related action according to the game situation,
automatically instruct the operation target character to perform the related action.

11. The storage medium of claim 8, wherein the program causes the processor to:
further accept a batch instruction of the plurality of operation target characters based on a user's operation.

12. The storage medium of claim 8, wherein the program causes the processor to:
display for each of the plurality of operation target characters, a plurality of individual operation units on a screen for the user to give the individual instruction for the action, and
display a parameter associated with the operation target character to be individually instructed in association with each of the plurality of individual operation units.

13. The storage medium of claim 8, wherein the program causes the processor to:
set beforehand a condition of the game situation for automatically instructing the related action based on a user's operation.

14. The storage medium of claim 8, wherein the program causes the processor to:
let the operation target character, to which the individual instruction is given, perform the action, and
let the operation target character to which the automatic instruction is given, perform the related action.

15. A game control apparatus including at least one processor, and a memory that cooperates with the processor and stores instructions to be executed by the processor, that controls a game including a plurality of operation target characters, and that, when executed by the processor, cause the processor to:
accept an individual instruction for an action of each of the plurality of operation target characters based on a user's operation; and
when accepting the individual instruction based on the user's operation for the action of some operation target character out of the plurality of operation target characters, give an automatic instruction according to a game situation for at least one other operation target character than the some operation target character individually instructed, to perform a related action to the action individually instructed to the some operation target character.
